(19) United States
(12) Patent Application Publication
(10) Pub. No.: US 2024/0413910 A1
(43) Pub. Date: Dec. 12, 2024

(54) OPTICAL TRANSCEIVER, OPTICAL COMMUNICATION SYSTEM, AND METHOD FOR CONTROLLING OPTICAL TRANSCEIVER

(71) Applicant: NEC Corporation, Minato-ku, Tokyo (JP)

(72) Inventor: Atsushi KOZATO, Tokyo (JP)

(73) Assignee: NEC Corporation, Minato-ku, Tokyo (JP)

(21) Appl. No.: 18/699,929

(22) PCT Filed: Nov. 15, 2021
(86) PCT No.: PCT/JP2021/041919

§ 371 Date: Apr. 10, 2024

(51) Int. Cl. H04B 10/556; G02B 6/293; H04B 10/54

(52) U.S. Cl. CPC H04B 10/5561; H04B 10/541; G02B 6/29395

(57) ABSTRACT

A wavelength-tunable optical transmission unit outputs an optical signal in which a signal to be superimposed for giving an instruction to another optical transceiver is superimposed on a main signal. A wavelength-tunable optical reception unit receives an optical signal from another optical transceiver. A control unit controls the wavelength-tunable optical transmission unit and the wavelength-tunable optical reception unit. The wavelength-tunable optical transmission unit superimposes, on the main signal, the signal to be superimposed, by modulating the main signal into a signal having a waveform whose amplitude transitions between two levels by amplitude shift-keying or phase shift-keying, and controls an amplitude of the superimposed signal based on a value obtained by multiplying an amplitude of the main signal by a predetermined ratio.

### TECHNICAL FIELD

The present invention relates to an optical transceiver, an optical communication system, and a method for controlling an optical transceiver.

### BACKGROUND ART

Optical communication systems that enable optical communication by connecting base stations on land to each other via optical cables have been widely used. Each of the base stations is provided with an optical transmission apparatus on which one or more optical transceivers are installed. In starting use of the optical transceiver, initial setting of the optical transceiver is performed.

There is disclosed a technology in which communication is started between optical transceivers after adjustment of a transmission speed, a data format, and a transmission format prior to data communication (Patent Literature 1). In this technology, a test signal in which a transmission speed and a transmission format between the optical transceivers are set is transmitted and received between the optical transceivers. The transmission speed is set by comparing a transmission speed used to transmit the test signal with a transmission speed of the received test signal. The transmission format is set to correspond to a transmission path state estimated according to error detection of the test signal. The data format is determined by transmitting and receiving information regarding the data format after the transmission speed and the transmission format are determined. After these are determined, communication between the optical transceivers is started.

Further, there is proposed a technique of starting bidirectional communication of a data packet between optical transceivers in a non-communication state (Patent Literature 2). In this technique, prior to the bidirectional communication of a data packet, a connection packet having specific information of each of the optical transceivers and having a low speed equal to or lower than a transmission speed of the data packet is transmitted and received between the optical transceivers via an optical fiber transmission path. Then, one of the optical transceivers is set as a master and the other is set as a slave according to the specific information of the connection packet received by each of the optical transceivers, and the optical transceiver serving as the slave is notified of a transmission method set by the optical transceiver serving as the master via a configuration packet. The bidirectional communication between the optical transceivers is performed by the set transmission method through this notification.

Furthermore, there is proposed a technique of performing negotiation of wavelengths to be used for communication between optical modules in a passive optical network (PON) system including an optical line terminal (OLT) and an optical network unit (ONU) (Patent Literature 3). In this technique, an optical module (referred to as a first optical module) periodically transmits a wavelength idle signal of a selected first wavelength to an optical module as a counterpart (referred to as a second optical module). The wavelength idle signal indicates that the selected first wavelength is available, and the second optical module having received the wavelength idle signal transmits, to the first optical module, a wavelength request message of a second wavelength corresponding to the first wavelength. When receiving the wavelength request message, the first optical module transmits a wavelength grant message to the second optical module to grant use of the selected wavelength. As a result, wavelengths to be used for transmission and reception of optical signals between the two optical modules are determined.

### CITATION LIST

### Patent Literature

Patent Literature 1: Japanese Unexamined Patent Application Publication No. 2005-229298
Patent Literature 2: Japanese Unexamined Patent Application Publication No. 2005-229299
Patent Literature 3: Published Japanese Translation of PCT International Publication for Patent Application, No. 2017-539142

### SUMMARY OF INVENTION

### Technical Problem

Generally, a plurality of optical transceivers are mounted on an optical transmission apparatus, and various settings such as setting of a channel (wavelength) to be used for transmission and reception by each optical transceiver are performed in the optical transmission apparatus (for example, Patent Literature 3). For this reason, a function of transmitting and receiving a signal instructing setting information or the like may be required between two corresponding optical transceivers. It is conceivable to transmit an instruction signal to an optical transceiver as a transmission destination after modulating a high-frequency main signal indicating a data signal and superimposing the instruction signal. However, in this case, it is required to establish a method of superimposing the instruction signal while maintaining the quality of the main signal.

The present invention has been made in view of the above circumstances, and an object of the present invention is to output an instruction signal from an optical transceiver after superimposing the instruction signal on a main signal while maintaining the quality of the main signal.

### Solution to Problem

An optical transceiver according to one aspect of the present invention includes: an optical transmission unit that outputs a first optical signal obtained by superimposing an optical signal for giving an instruction to another optical transceiver on a first main signal that is an optical signal for transmitting communication data to the other optical transceiver: an optical reception unit that receives a second optical signal from the other optical transceiver; and a control unit that controls the optical transmission unit and the optical reception unit, in which the optical transmission unit modulates the first main signal into a signal having a waveform whose amplitude transitions between two levels by amplitude shift-keying or phase shift-keying to superimpose a first superimposed signal, which is the optical signal superimposed on the first main signal, on the first main signal, and controls an amplitude of the first superimposed signal based on a value obtained by multiplying an amplitude of the first main signal by a predetermined ratio.

An optical communication system according to one aspect of the present invention includes: two opposing optical transmission apparatuses each including a plurality of optical transceivers and a first optical multiplexer/demultiplexer that multiplexes and outputs optical signals output from the plurality of optical transceivers and demultiplexes the received optical signals to the plurality of optical transceivers according to a channel; and an optical cable that connects the two opposing optical transmission apparatuses, in which each of the optical transceivers of one of the optical transmission apparatuses includes an optical transmission unit that outputs an optical signal obtained by superimposing an optical signal for giving an instruction to the other optical transceivers of the other optical transmission apparatus on a main signal that is an optical signal for transmitting communication data to the other optical transceivers: an optical reception unit that receives optical signals from the other optical transceivers, and a control unit that controls the optical transmission unit and the optical reception unit, and each of the optical transmission units modulates the main signal into a signal having a waveform whose amplitude transitions between two levels by amplitude shift-keying or phase shift-keying to superimpose a superimposed signal, which is the optical signal superimposed on the main signal, on the main signal, and controls an amplitude of the superimposed signal based on a value obtained by multiplying an amplitude of the main signal by a predetermined ratio.

A method for controlling an optical transceiver according to one aspect of the present invention, the optical transceiver including an optical transmission unit that outputs an optical signal obtained by superimposing an optical signal for giving an instruction to another optical transceiver on a main signal that is an optical signal for transmitting communication data to the other optical transceiver, an optical reception unit that receives an optical signal from the other optical transceiver, and a control unit that controls the optical transmission unit and the optical reception unit, includes: modulating the main signal into a signal having a waveform whose amplitude transitions between two levels by amplitude shift-keying or phase shift-keying to superimpose a superimposed signal, which is the optical signal superimposed on the main signal, on the main signal; and controlling an amplitude of the superimposed signal based on a value obtained by multiplying an amplitude of the main signal by a predetermined ratio.

### Advantageous Effects of Invention

According to the present invention, an instruction signal can be superimposed on a main signal and output from an optical transceiver while the quality of the main signal is maintained.

### BRIEF DESCRIPTION OF DRAWINGS

FIG. 1 is a diagram schematically illustrating a basic configuration of an optical communication system according to a first example embodiment.

FIG. 2 is a diagram schematically illustrating a configuration of an optical transmission apparatus according to the first example embodiment and an example of transmission and reception of optical signals.

FIG. 3 is a diagram schematically illustrating a configuration of a channel setting optical signal.

FIG. 4 is a diagram schematically illustrating a basic configuration of an optical transceiver according to the first example embodiment.

FIG. 5 is a diagram illustrating the configuration of the optical transceiver according to the first example embodiment in more detail.

FIG. 6 is a diagram illustrating transmission of the channel setting optical signal in the optical transceiver according to the first example embodiment.

FIG. 7 is a diagram illustrating reception of the channel setting optical signal in the optical transceiver according to the first example embodiment.

FIG. 8 is a diagram illustrating an example of channel setting optical signals transmitted and received between two optical transceivers in channel setting processing.

FIG. 9 is a diagram illustrating a state transition the channel setting processing.

FIG. 10 is a diagram schematically illustrating a configuration of an optical transceiver according to a second example embodiment.

FIG. 11 is a diagram illustrating an example of channel setting optical signals transmitted and received between two optical transceivers in channel setting processing in the second example embodiment.

FIG. 12 is a diagram schematically illustrating a configuration of an optical transceiver according to a third example embodiment.

FIG. 13 is a diagram schematically illustrating a configuration of an optical communication system according to the third example embodiment and an example of transmission and reception of optical signals.

FIG. 14 is a diagram schematically illustrating a signal flow in a case where an optical transceiver as a communication partner is controlled in the third example embodiment.

FIG. 15 is a diagram schematically illustrating a signal flow in a case where a host apparatus to which the optical transceiver as the communication partner is connected is controlled in the third example embodiment.

FIG. 16 is a diagram schematically illustrating a configuration of an optical transceiver according to a fourth example embodiment.

FIG. 17 is a diagram schematically illustrating a configuration of a wavelength-tunable optical transmission unit according to the fourth example embodiment.

FIG. 18 is a view schematically illustrating a waveform and an eye pattern of a main signal before and after modulation is performed.

FIG. 19 is a diagram illustrating a comparative example in which a main signal is modulated and a signal to be superimposed is superimposed.

FIG. 20 is a diagram illustrating a change in the amplitude of a superimposed signal in a comparative example in a case where an amplification factor increases due to a variation in characteristics of an optical transceiver.

FIG. 21 is a diagram illustrating a change in the amplitude of the superimposed signal in the comparative example in a case where the amplification factor decreases due to a variation in the characteristics of the optical transceiver.

FIG. 22 is a diagram illustrating a signal waveform in a case where the amplitude of a superimposed signal SP1 is controlled according to the amplitude of an amplified main signal MS1 in the transceiver according to the first example embodiment.

FIG. 23 is a diagram schematically illustrating a configuration of an optical transceiver according to a fifth example embodiment.

FIG. 24 is a diagram illustrating a relationship between a signal and bits in Manchester encoding.

FIG. 25 is a diagram illustrating an example of an optical signal transmitted by an optical transceiver on a transmission side.

FIG. 26 is a diagram illustrating an example of a superimposed signal for bit synchronization.

FIG. 27 is a flowchart illustrating a procedure of a bit synchronization operation in a seventh example embodiment.

FIG. 28 is a diagram illustrating a first example of the bit synchronization operation.

FIG. 29 is a diagram illustrating a second example of the bit synchronization operation.

### EXAMPLE EMBODIMENTS

Hereinafter, example embodiments of the present invention will be described with reference to the drawings. In the drawings, the same elements are denoted by the same reference signs, and redundant description will be omitted as necessary.

### First Example Embodiment

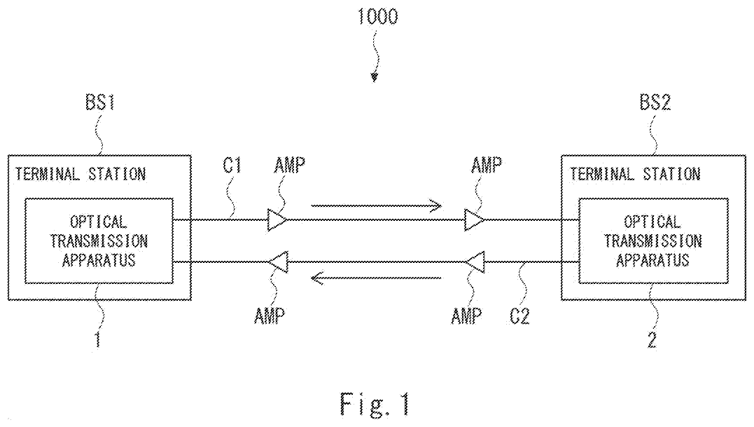

An optical communication system 1000 according to a first example embodiment will be described. FIG. 1 schematically illustrates a basic configuration of the optical communication system 1000 according to the first example embodiment. In the optical communication system 1000, optical transmission apparatuses 1 and 2 are provided in terminal stations BS1 and BS2 on land, respectively. The optical transmission apparatuses 1 and 2 are connected by optical cables C1 and C2. The optical cables C1 and C2 may be laid on land or on the sea floor. In this example, the optical cable C1 is used as a cable for transmitting an optical signal that is transmitted from the optical transmission apparatus 1 to the optical transmission apparatus 2. The optical cable C2 is used as a cable for transmitting an optical signal that is transmitted from the optical transmission apparatus 2 to the optical transmission apparatus 1. Note that one or more optical amplifiers AMP may be inserted into the optical cables C1 and C2 in order to compensate for an optical signal attenuated by the transmission.

FIG. 1 illustrates a simplified configuration of the optical communication system for simplification. For example, one optical transmission apparatus may be communicably connected to two or more optical transmission apparatuses by optical cables. Further, an optical add/drop multiplexer that adds and drops optical signals may be inserted into the optical cables as necessary to cause a trunk path to be branched into branch paths. However, these are merely examples, and it goes without saying that the optical communication system may have a configuration having any path (trunk path and branch path) that enables optical communication between any number of optical transmission apparatuses.

A configuration of each of the optical transmission apparatuses will be described. The optical transmission apparatus includes a plurality of optical transceivers, an optical multiplexer that multiplexes optical signals to be transmitted and outputs a multiplexed optical signal, and an optical demultiplexer that demultiplexes a received multiplexed optical signal into each of the optical transceivers. Hereinafter, the optical multiplexer and the optical demultiplexer are integrated and handled as one optical multiplexer/demultiplexer for simplification.

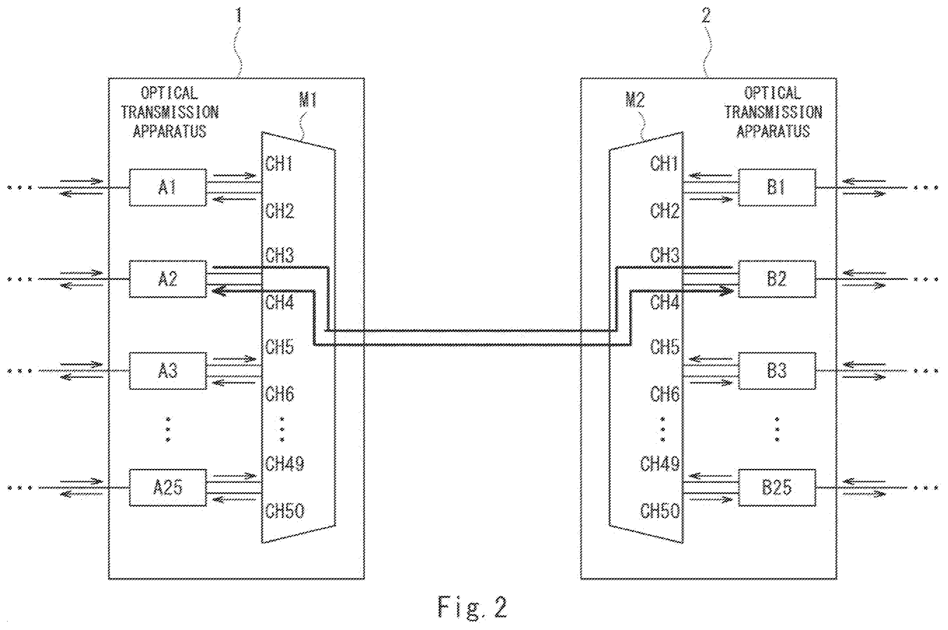

FIG. 2 schematically illustrates configurations of the optical transmission apparatuses 1 and 2 according to the first example embodiment and an example of transmission and reception of optical signals. The optical transmission apparatus 1 includes a plurality of optical transceivers and an optical multiplexer/demultiplexer M1 (also referred to as a second optical multiplexer/demultiplexer). Here, an example in which the optical transmission apparatus 1 includes 25 optical transceivers A1 to A25 is illustrated. Two different channels are assigned to each of the optical transceivers A1 to A25.

Ports of the optical multiplexer/demultiplexer M1 connected to the optical transceivers are provided as many as the number of channels, and a transmission port and a reception port of an optical transceiver Ai (i is an integer greater than or equal to 1 and less than or equal to 25) are connected to a port of a channel CH(2i−1) and a port of a channel CH(2i), respectively, of the optical multiplexer/demultiplexer M1. In other words, the channel CH(2i−1) for transmission and the channel CH(2i) for reception are assigned to the optical transceiver Ai. That is, channels CH1 and CH2, channels CH3 and CH4, channels CH5 and CH6, . . . , and channels CH49, and CH50 are assigned to the optical transceivers A1, A2, A3, . . . , and A25, respectively. In this manner, a specific channel is assigned to each of the two ports of each of the optical transceivers without overlapping in the optical transmission apparatus.

The optical transmission apparatus 2 has a configuration similar to that of the optical transmission apparatus 1. That is, the optical transmission apparatus 2 includes 25 optical transceivers B1 to B25 and an optical multiplexer/demultiplexer M2 (also referred to as a first optical multiplexer/demultiplexer).

Ports of the optical multiplexer/demultiplexer M2 connected to the optical transceivers are provided as many as the number of channels, and a reception port and a transmission port of an optical transceiver Bi are connected to a port for the channel CH(2i−1) and a port for the channel CH(2i), respectively, of the optical multiplexer/demultiplexer M2. In other words, the channel CH(21) for transmission and the channel CH(2i−1) for reception are assigned to the optical transceiver Bi. That is, the channels CH1 and CH2, the channels CH3 and CH4, the channels CH5 and CH6, . . . , and the channels CH49, and CH50 are assigned to the optical transceivers B1, B2, B3, . . . , and B25, respectively. In this manner, a specific channel is assigned to each of the two ports of each of the optical transceivers without overlapping in the optical transmission apparatus.

With the above configuration, two common channels are assigned to the optical transceiver Ai and the optical transceiver Bi, and transmission and reception of an optical signal can be performed using these two channels.

In this example, a transmission/reception path of an optical signal is illustrated by focusing on the optical transceiver A2 of the optical transmission apparatus 1 and the optical transceiver B2 of the optical transmission apparatus 2. The optical transceiver A2 transmits an optical signal using the channel CH3, and the transmitted optical signal for the channel CH3 is received by the optical transceiver B2. Further, the optical transceiver B2 transmits an optical signal using the channel CH4, and the transmitted optical signal for the channel CH4 is received by the optical transceiver A2.

Note that FIG. 2 merely focuses on the optical transceiver A2 and the optical transceiver B2 for simplification of description, and it goes without saying that other optical transceivers can similarly transmit and receive optical signals using two channels.

In this manner, a channel to be used for an optical transceiver on a transmission side and an optical transceiver on a reception side is set for transmission and reception of an optical signal of a specific channel. In general, the work of setting a channel for an optical transceiver is performed as initial setting work performed when the optical transceiver is attached to an optical transmission apparatus.

However, for example, in a case where up to 50 channels are used as in the above-described optical communication system, it is necessary to perform the setting work for two channels for each of a total of 50 optical transceivers in the two optical transmission apparatuses, that is, to perform the setting work 100 times. However, if this setting work is manually performed, there is a problem that a required work time is enormous. Further, it is also necessary to perform the setting work a lot of times without any mistake, and thus, it can be considered that there is a problem in the manual setting work even from the viewpoint of reliability.

In this regard, in order to cope with such problems, the present example embodiment describes an optical transceiver that autonomously performs channel setting processing when the optical transceiver is attached to an optical transmission apparatus.

For example, in a case where the optical transceiver A2 and the optical transceiver B2 are attached to the optical transmission apparatuses, the optical transceiver A2 and the optical transceiver B2 autonomously execute the channel setting processing. At this time, channel setting optical signals are transmitted and received between the optical transceiver A2 and the optical transceiver B2.

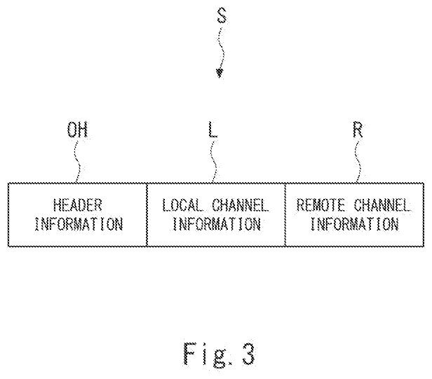

FIG. 3 schematically illustrates a configuration of the channel setting optical signal. The channel setting optical signal S includes at least local channel information L and remote channel information R held in an optical transceiver. The local channel information L is information indicating a channel of the transmitted channel setting optical signal S when the optical transceiver transmits the channel setting optical signal S in the channel setting processing.

The remote channel information R is information indicating a channel of the received channel setting optical signal S when the optical transceiver receives the channel setting optical signal S in the channel setting processing. Note that the channel setting optical signal S may include other information as necessary. FIG. 3 illustrates an example in which the channel setting optical signal S includes header information OH.

In the present example embodiment, the channel setting optical signal is transmitted by being superimposed on a main signal modulated based on a data signal to be transmitted and received, the data signal being exchanged between two optical transceivers (for example, the above-described optical transceivers A2 and B2) that transmit and receive optical signals. The channel setting optical signal can be transmitted by being superimposed on the main signal by using modulation schemes such as amplitude-shift keying (ASK), phase-shift keying (PSK), and frequency-shift keying (FSK). Note that the modulation schemes described here are merely examples, and various modulation schemes can be applied as long as the channel setting optical signal can be superimposed on the main signal.

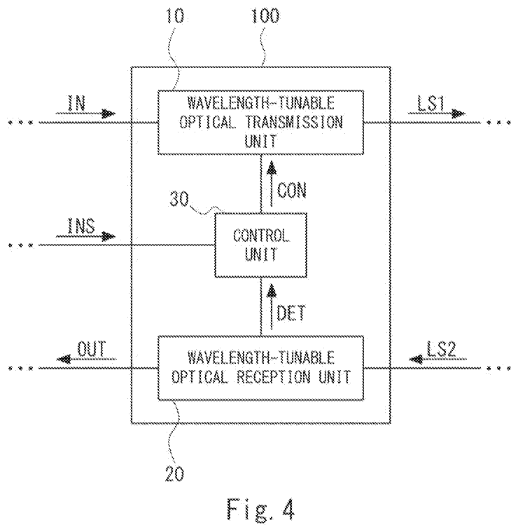

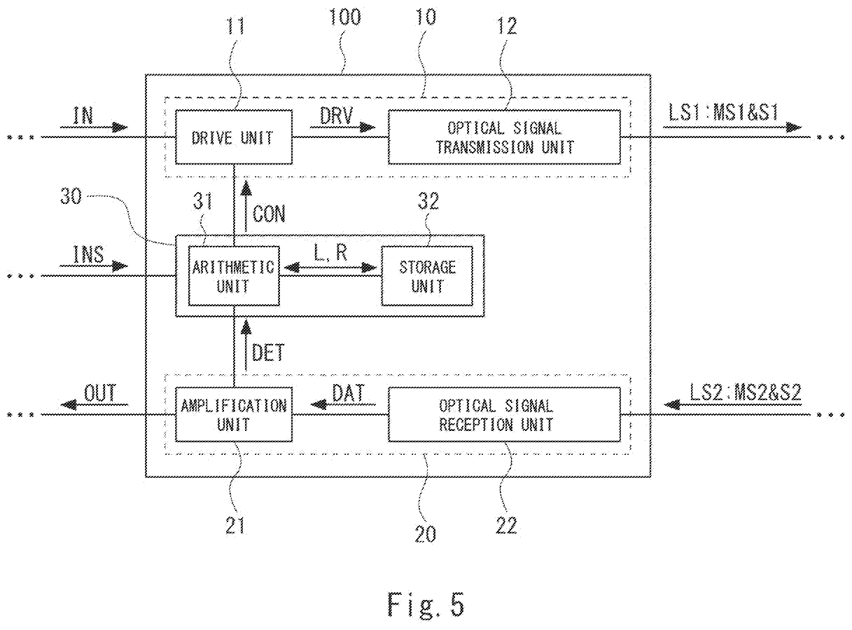

Here, a configuration of each of the optical transceivers according to the present example embodiment will be described. FIG. 4 schematically illustrates a basic configuration of the optical transceiver according to the first example embodiment. FIG. 5 illustrates a configuration of the optical transceiver according to the first example embodiment in more detail. Note that the optical transceivers A1 to A25 and B1 to B25 have a similar configuration, and thus, an optical transceiver 100 having the same structure as the optical transceivers A1 to A25 and B1 to B25 will be described as a representative.

The optical transceiver 100 includes a wavelength-tunable optical transmission unit 10, a wavelength-tunable optical reception unit 20, and a control unit 30. The control unit 30 controls operations of the wavelength-tunable optical transmission unit 10 and the wavelength-tunable optical reception unit 20 according to an instruction signal INS provided from an optical transmission apparatus on which the optical transceiver 100 is mounted, for example. The control unit 30 includes an arithmetic unit 31 and a storage unit 32.

The wavelength-tunable optical transmission unit 10 is configured to be capable of changing a wavelength, that is, a channel of an optical signal to be transmitted. The wavelength-tunable optical transmission unit 10 includes a drive unit 11 and an optical signal transmission unit 12. The drive unit 11 outputs a drive signal DRV to the optical signal transmission unit 12 based on a received main signal (data signal) IN. The wavelength-tunable optical signal transmission unit 12 is configured as, for example, a transmitter optical sub-assembly (TOSA), and is configured to be capable of outputting an optical signal LS1 modulated according to the drive signal DRV. As described above, the optical transceiver 100 can output a channel setting optical signal superimposed on the main signal. Therefore, the optical signal LS1 modulated according to the drive signal DRV is an optical signal including only a main signal MS1 or an optical signal in which a channel setting optical signal S1 is superimposed on the main signal MS1.

The wavelength-tunable optical reception unit 20 is configured to be capable of changing a wavelength, that is, a channel of an optical signal to be received. The wavelength-tunable optical reception unit 20 includes an amplification unit 21 and an optical signal reception unit 22. The wavelength-tunable optical signal reception unit 22 is configured as, for example, a receiver optical sub-assembly (ROSA), converts a received optical signal LS2 into an output signal DAT which is an electrical signal, and outputs the output signal to the amplification unit 21. The amplification unit 21 is configured as, for example, a limiting amplifier, amplifies the output signal DAT to a predetermined amplitude, and outputs the amplified output signal OUT to the outside of the optical transceiver 100, for example, the optical transmission apparatus in which the optical transceiver 100 is mounted. As described above, the optical transceiver 100 can receive an optical signal in which a channel setting optical signal is superimposed on a main signal. Therefore, the optical signal LS2 is an optical signal including only a main signal MS2 or a signal in which a channel setting optical signal S2 is superimposed on the main signal MS2. When an optical signal in which the channel setting optical signal S is superimposed on a main signal MS is received, the amplification unit 21 separates the output signal OUT based on the main signal MS from the output signal DAT and outputs the separated output signal, and separates a detection signal DET based on the channel setting optical signal S2 from the output signal DAT and outputs the separated detection signal to the arithmetic unit 31 of the control unit 30.

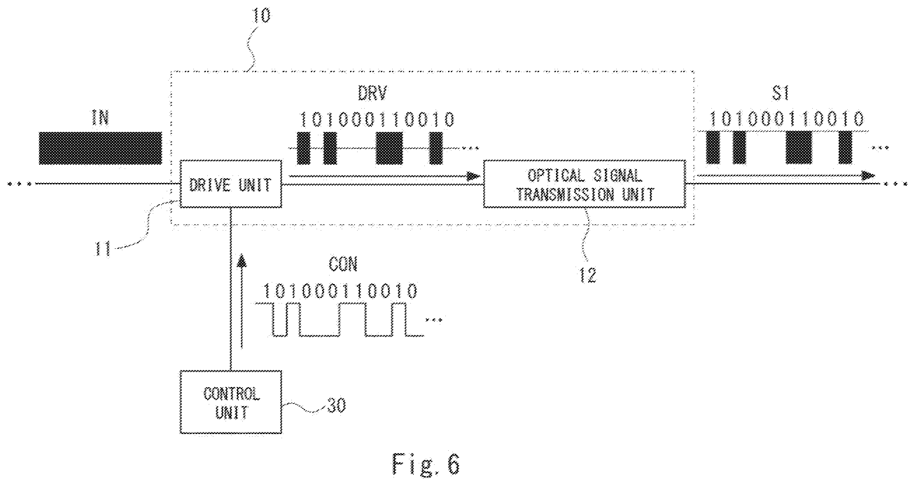

Next, transmission of a channel setting optical signal in the optical transceiver 100 will be described. FIG. 6 illustrates transmission of a channel setting optical signal SA in the optical transceiver 100. Note that FIG. 6 focuses on the channel setting optical signal S1, and thus, does not illustrate the main signal MS1. The arithmetic unit 31 of the control unit 30 can superimpose a signal for channel setting on the drive signal DRV output from the drive unit 11 by giving a control signal CON to the drive unit 11. At this time, the local channel information L and the remote channel information R are added to the control signal CON so that the channel setting optical signal S1 superimposed on the main signal MS1 output by the optical signal transmission unit 12 includes the local channel information L and the remote channel information R. The arithmetic unit 31 can appropriately read the local channel information L and the remote channel information R included in the channel setting signal S1 from the storage unit 32 from the arithmetic unit 32. FIG. 6 illustrates an example of the channel setting optical signal S1, and it goes without saying that the channel setting optical signal S1 can be appropriately modulated according to a modulation scheme so as to be superimposed on the main signal MS1.

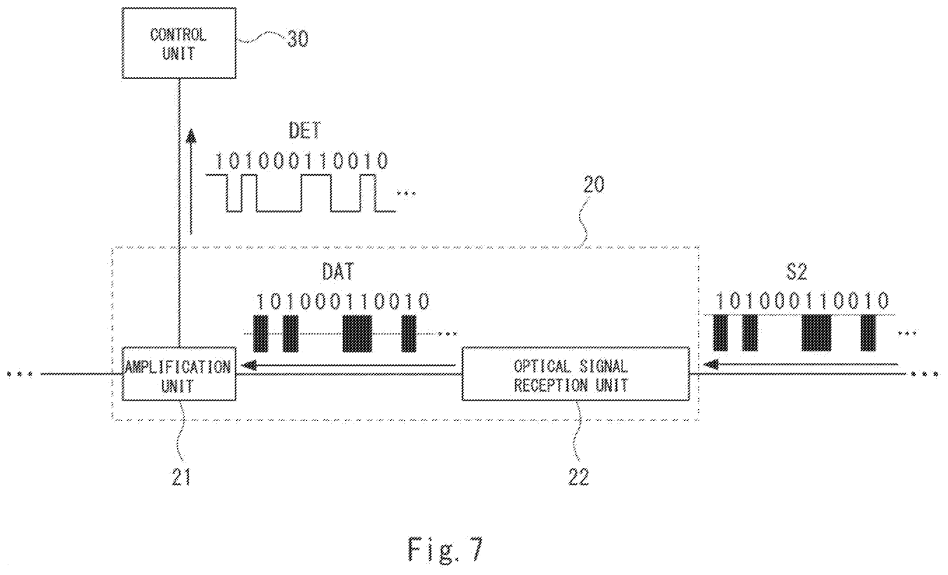

Next, reception of a channel setting optical signal in the optical transceiver 100 will be described. FIG. 7 illustrates reception of a channel setting optical signal SB in the optical transceiver 100. FIG. 7 focuses on the channel setting optical signal S2, and thus, does not illustrate the main signal MS2. When the optical signal reception unit 22 receives an optical signal on which the channel setting optical signal S2 is superimposed, the amplification unit 21 outputs the detection signal DET based on the channel setting optical signal S2 to the arithmetic unit 31 of the control unit 30. As a result, the control unit 30 can receive the local channel information L and the remote channel information R. The arithmetic unit 31 can appropriately write the received local channel information L and remote channel information R to the storage unit 32. FIG. 7 illustrates an example of the channel setting optical signal S2, and it goes without saying that the channel setting optical signal S2 can be appropriately modulated according to a modulation scheme so as to be superimposed on the main signal MS2.

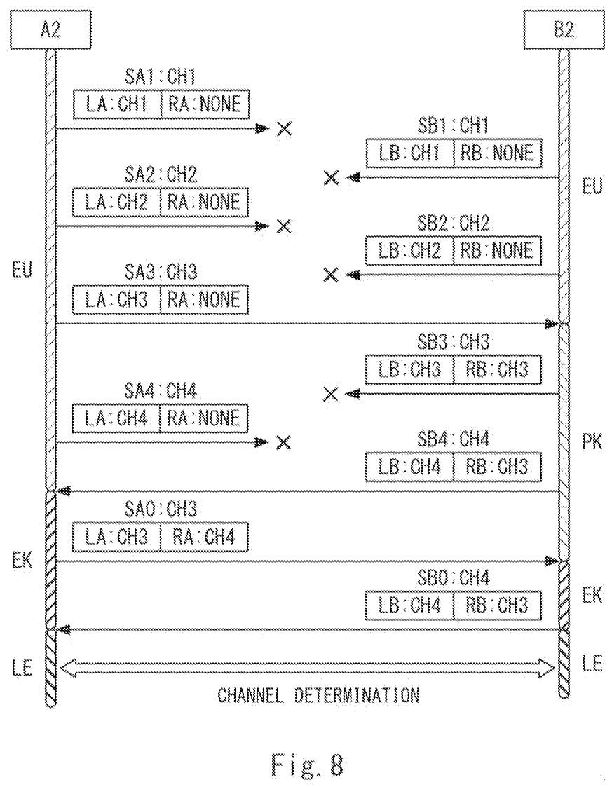

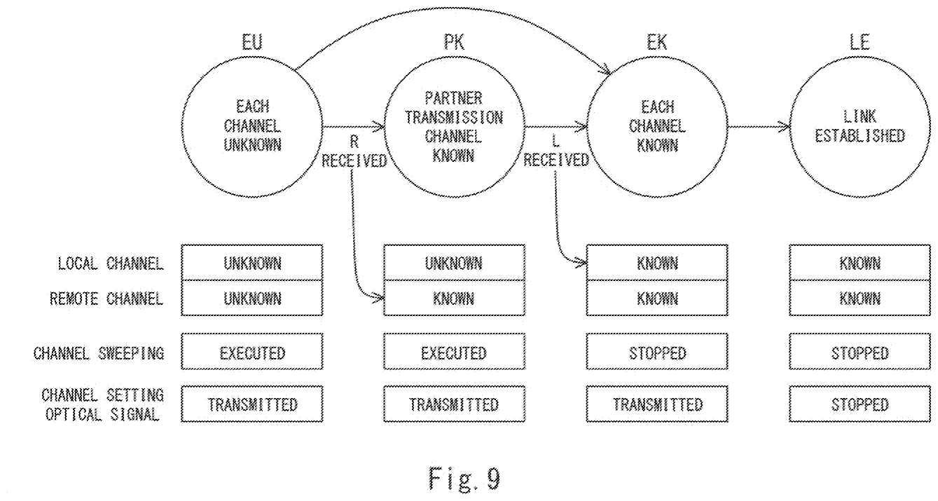

Next, the above-described channel setting processing of the optical transceiver using the channel setting optical signal will be described. The optical transceiver A2 and the optical transceiver B2 transmit channel setting optical signals while changing the local channel information L, that is, sweeping a local channel, thereby determining channels to be used for transmission and reception of optical signals therebetween in the following procedure. FIG. 8 illustrates an example of the channel setting optical signals transmitted and received between the optical transceiver A2 and the optical transceiver B2 in the channel setting processing. FIG. 9 illustrates a state transition in the channel setting processing.

At the time of starting the channel setting processing, the optical transceivers A2 and B2 are in a state (hereinafter, a state EU: Each channel Unknown) where a transmission channel and a reception channel that need to be set are unknown. That is, both an optical transceiver serving as a transmission destination and an optical transceiver that transmits a received optical signal are not specified in the state.

Thereafter, the optical transceivers A2 and B2 repeatedly transmit the channel setting optical signals while sweeping a local channel. Here, it is assumed that the local channel is swept in ascending order starting from the channel CH1.

Note that the optical transceiver B2 and the optical transceiver A2 are also hereinafter referred to as a first optical transceiver and a second optical transceiver, respectively. The channel setting optical signal output from the optical transceiver B2 is also referred to as a first channel setting optical signal.

The channel setting optical signal output from the optical transceiver A2 is also referred to as a second channel setting optical signal.

The channel CH3 and the channel CH4 are also referred to as a first channel and a second channel, respectively.

The local channel information LB of the optical transceiver B2 is also referred to as first channel information, and the local channel information LA of the optical transceiver A2 is also referred to as second channel information. The remote channel information RB of the optical transceiver B2 is also referred to as third channel information, and the local channel information LA of the optical transceiver A2 is also referred to as second channel information.

### (1) SA1/LA: CH1 and RA: None

In the example of FIG. 8, the optical transceiver A2 first transmits a channel setting optical signal SA1 for the channel CH1 in which the local channel information LA indicates the channel CH1 and the remote channel information RA is empty (NONE). In this example, the channel CH1 is a channel to be used for transmission from the optical transceiver A1 to the optical transceiver B1. That is, the reception port of the optical transceiver B1 is connected to the port for the channel CH1 in the optical multiplexer/demultiplexer M2 of the optical transmission apparatus 2. Therefore, the channel setting optical signal SA1 is blocked by the optical multiplexer/demultiplexer M2 and does not reach the optical transceiver B2.

### (2) SB1/LB: CH1 and RB: None

Next, the optical transceiver B2 transmits a channel setting optical signal SB1 for the channel CH1 in which the local channel information LB indicates the channel CH1 and the remote channel information RB is empty (NONE). Since the transmission port of the optical transceiver A1 is connected to the port for the channel CH1 in the optical multiplexer/demultiplexer M1 of the optical transmission apparatus 1, the channel setting optical signal SB1 is blocked by the optical multiplexer/demultiplexer M1 and does not reach the optical transceiver A2.

### (3) SA2/LA: CH2 and RA: None

Next, the optical transceiver A2 transmits a channel setting optical signal SA2 for the channel CH2 in which the local channel information LA indicates the channel CH2 and the remote channel information RA is empty (NONE). In this example, the channel CH2 is a channel to be used for transmission from the optical transceiver B1 to the optical transceiver A1. That is, the transmission port of the optical transceiver B1 is connected to the port for the channel CH2 in the optical multiplexer/demultiplexer M2 of the optical transmission apparatus 2. Therefore, the channel setting optical signal SA2 is blocked by the optical multiplexer/demultiplexer M2 and does not reach the optical transceiver B2.

### (4) SB2/LA: CH2 and RA: None

Next, the optical transceiver B2 transmits a channel setting optical signal SB2 for the channel CH2 in which the local channel information LB indicates the channel CH2 and the remote channel information RB is empty (NONE). Since the reception port of the optical transceiver A1 is connected to the port for the channel CH2 in the optical multiplexer/demultiplexer M1 of the optical transmission apparatus 1, the channel setting optical signal SB2 is blocked by the optical multiplexer/demultiplexer M1 and does not reach the optical transceiver A2.

### (5) SA3/LA: CH3 and RA: None, and State Transition: EU to PK

Next, the optical transceiver A2 transmits a channel setting optical signal SA3 for the channel CH3 in which the local channel information L indicates the channel CH3 and the remote channel information R is empty (NONE). In this example, the channel CH3 is a channel to be used for transmission from the optical transceiver A2 to the optical transceiver B2. That is, the reception port of the optical transceiver B2 is connected to the port for the channel CH3 in the optical multiplexer/demultiplexer M2 of the optical transmission apparatus 2. Therefore, the channel setting optical signal SA3 for the channel CH3 is received by the optical transceiver B2 via the optical multiplexer/demultiplexer M2.

As a result, the optical transceiver B2 can receive the channel CH3 as the local channel information LA of the optical transceiver A2. Since the local channel information LA of the optical transceiver A2 is the remote channel information RB for the optical transceiver B2, the optical transceiver B2 fixes the remote channel information RB to the channel CH3.

At this time, the optical transceiver B2 is in a state (state PK: Partner CH Known) in which a transmission channel of the optical transceiver A2 as a partner is detected, and the state transitions from EU to PK.

### (6) SB4/LB: CH3 and RB: None

Next, the optical transceiver B2 transmits a channel setting optical signal SB3 for the channel CH3 in which the local channel information LB indicates the channel CH3 and the remote channel information RB indicates the channel CH3. Since the transmission port of the optical transceiver A2 is connected to the port for the channel CH3 in the optical multiplexer/demultiplexer M1 of the optical transmission apparatus 1, the channel setting optical signal SB3 for the channel CH3 is blocked by the optical multiplexer/demultiplexer M1 and does not reach the optical transceiver A2.

### (7) SA4/LA: CH4 and RA: None

Next, the optical transceiver A2 transmits a channel setting optical signal SA4 for the channel CH4 in which the local channel information LA indicates the channel CH4 and the remote channel information RA is empty (NONE). In this example, the channel CH4 is a channel to be used for transmission from the optical transceiver B2 to the optical transceiver A2. That is, the transmission port of the optical transceiver B2 is connected to the port for the channel CH4 in the optical multiplexer/demultiplexer M2 of the optical transmission apparatus 2. Therefore, the channel setting optical signal SA4 for the channel CH4 is blocked by the optical multiplexer/demultiplexer M2 and does not reach the optical transceiver B2.

### (8) SB4/LB: CH4 and RA: CH3, and State Transition: EU to EK

Next, the optical transceiver B2 transmits a channel setting optical signal SB4 for the channel CH4 in which the local channel information LB indicates the channel CH4 and the remote channel information RB indicates the channel CH3. The reception port of the optical transceiver B2 is connected to the port for the channel CH4 in the optical multiplexer/demultiplexer M1 of the optical transmission apparatus 1. Therefore, the channel setting optical signal SB4 for the channel CH4 is received by the optical transceiver A2 via the optical multiplexer/demultiplexer M1.

As a result, the optical transceiver A2 can receive the channel CH4 as the local channel information LB of the optical transceiver B2. Since the local channel information LB of the optical transceiver B2 is the remote channel information RA for the optical transceiver A2, the optical transceiver A2 fixes the remote channel information RA to the channel CH4.

Further, the optical transceiver A2 can receive the channel CH3 as the remote channel information RB of the optical transceiver B2. Since the remote channel information RB of the optical transceiver B2 is the local channel information LA for the optical transceiver A2, the optical transceiver A2 fixes the local channel information LA to the channel CH3. Note that the transmission channel of the optical transceiver A2 is set by fixing the local channel information LA to the channel CH3, and thus, the optical transceiver A2 stops sweeping a channel.

At this time, the optical transceiver A2 is in a state (state EK: Each CH Known) in which a transmission channel of the optical transceiver B2 as a partner and a channel through which transmission from the optical transceiver A2 to the optical transceiver B2 is possible are detected, and the state transitions from EU to EK.

### (9) SA0/LA: CH3 and RA: CH4, and State Transition: PK to EK

Next, the optical transceiver A2 transmits a channel setting optical signal SA0 for the channel CH3 in which the local channel information LA is fixed to the channel CH3 and the remote channel information RA is fixed to the channel CH4. The channel setting optical signal SA0 for the channel CH3 is received by the optical transceiver B2.

In this case, the optical transceiver B2 can receive the channel CH4 as the remote channel information RA of the optical transceiver A2. Since the remote channel information RA of the optical transceiver A2 is the local channel information LB for the optical transceiver B2, the optical transceiver B2 fixes the local channel information LB to the channel CH4. Note that the transmission channel of the optical transceiver B2 is set by fixing the local channel information LB to the channel CH4, and thus, the optical transceiver B2 stops the channel sweeping.

At this time, the optical transceiver B2 is in a state (state EK) in which the transmission channel of the optical transceiver A2 as the partner and a channel through which transmission from the optical transceiver B2 to the optical transceiver A2 is possible are detected, and the state transitions from PK to EK.

### (10) SB0/LB: CH4 and RB: CH3, and State Transition: EK to LE

Next, the optical transceiver B2 transmits a channel setting optical signal SB0 for the channel CH4 in which the local channel information LB is fixed to the channel CH4 and the remote channel information RB is fixed to the channel

CH3. The channel setting optical signal SB0 for the channel CH4 is received by the optical transceiver A2.

In this case, the optical transceivers A2 and B2 can confirm that the local channel information LA of the optical transceiver A2 and the remote channel information RB of the optical transceiver B2 coincide as the channel CH3, and the local channel information LB of the optical transceiver B2 and the remote channel information RA of the optical transceiver A2 coincide as the channel CH4. Therefore, in this case, the optical transceivers A2 and B2 can confirm that the channel to be used for transmission and the channel to be used for reception have been determined. Therefore, since no further channel setting processing is required, the optical transceivers A2 and B2 end the channel setting processing on the assumption that a link is established (state LE: Link Established).

As a result, after the channel setting processing is completed, the optical transceiver A2 and the optical transceiver B2 can transmit and receive optical signals using the channels CH3 and CH4.

As described above, according to the present configuration, an optical transceiver can autonomously set a channel of an optical signal to be transmitted and a channel of an optical signal to be received by referring to information included in a received channel setting signal.

As a result, a time required for channel setting of the optical transceiver can be shortened, for example, in a case where many channels are used as in the above-described optical communication system.

In the manual channel setting work, it is conceivable that a work time in units of minutes, for example, a work time of about 10 minutes is required for work of setting one channel. On the other hand, according to the present configuration, automatic setting of one channel can be performed in a setting time in units of seconds, for example, in a setting time of about several seconds although there is a variation depending on a configuration of the optical communication system. In this manner, it can be understood that the time required for channel setting of the optical transceiver can be significantly shortened according to the present configuration.

Further, since the optical transceiver autonomously performs the channel setting, not only the manual work of a worker can be reduced, but also the worker can perform other work during the channel setting processing, which is advantageous in terms of labor saving.

Furthermore, since the optical transceiver can autonomously perform the channel setting, it is possible to prevent a mistake, such as setting a wrong channel, which is likely to occur due to the manual channel setting work, and it is also possible to improve reliability of the channel setting.

Note that there may be a case where optical transceivers fewer than the maximum installable number are installed on an optical transmission apparatus and started to operate, and thereafter, an additional optical transceiver is installed. In this case, in order to manually perform channel setting, it is necessary to perform complicated work such as investigating a channel that is already used and setting a channel other than the channel that is being used. On the other hand, in the optical transceiver according to the present example embodiment, the channel setting can be autonomously performed even if a channel that is already used is not known, which is also advantageous in terms of time reduction and labor saving of work at the time of installing an additional optical transceiver.

Although the above description has focused on the optical transceivers A2 and B2, it goes without saying that the channel setting processing can be similarly executed for the other optical transceivers A1, A3 to A25, B1, and B3 to B25. Note that the case where the optical transceiver changes the channel of the channel setting optical signal in ascending order from the channel CH1 has been described in the above description, but this is merely an example. For example, the optical transceiver may change the channel of the channel setting optical signal in descending order. Further, for example, the optical transceiver may change the channel of the channel setting optical signal in any order other than the descending order and the ascending order.

### Second Example Embodiment

Although the optical transceiver that autonomously performs the channel setting has been described in the first example embodiment, work can be sometimes made efficient by manually performing the channel setting in a case where a channel to be used by the optical transceiver is known in advance. Although the optical transceiver according to the first example embodiment sweeps a channel when performing the channel setting, there may be a case where the number of swept channels increases until the channel reaches a channel to be set. In this case, it takes a long time to complete the channel setting. On the other hand, in a case where a channel to be used by the optical transceiver is known, the channel sweeping can be reduced by manually performing the channel setting even after the autonomous channel setting is started. As a result, a time required for the channel setting can be reduced, and the efficiency of the channel setting work can be expected.

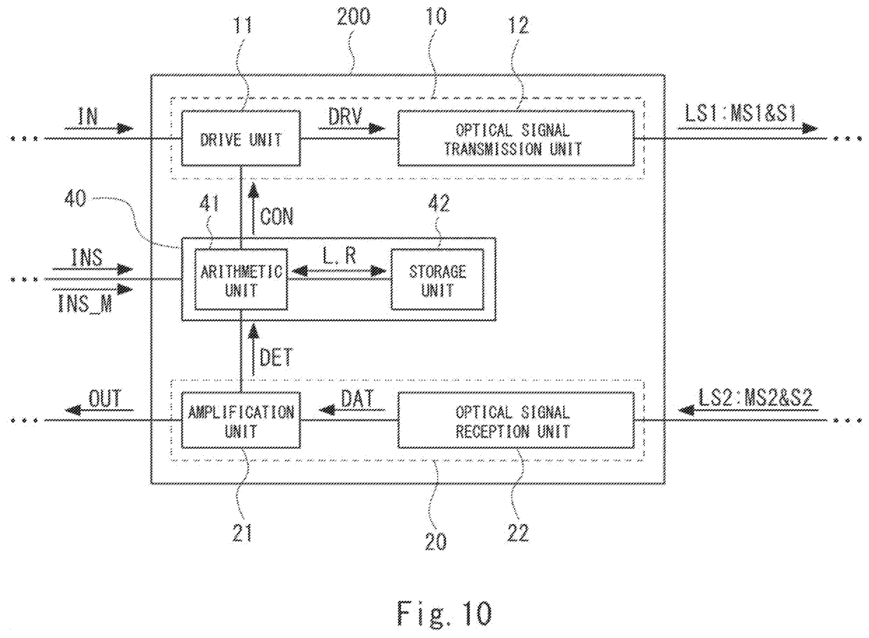

In this regard, an optical transceiver capable of not only autonomous channel setting but also manual channel setting will be described in the present example embodiment. FIG. 10 schematically illustrates a configuration of an optical transceiver 200 according to a second example embodiment. The optical transceiver 200 has a configuration in which the control unit 30 of the optical transceiver 100 is replaced with a control unit 40. An arithmetic unit 41 and a storage unit 42 of the control unit 40 correspond to the arithmetic unit 31 and the storage unit 32 of the control unit 30, respectively. The control unit 40 is configured to be able to perform channel setting according to an instruction signal INS_M, which is given from a user of the optical transceiver 200 or an apparatus such as a host apparatus connected to the optical transceiver 200 and instructs the manual channel setting in addition to operations similar to those of the control unit 30.

Next, manual channel setting processing in the present example embodiment will be described. Here, similarly to FIG. 2, it is assumed that the optical transmission apparatus 1 is provided with the optical transceivers A1 to A25 each having the same configuration as the optical transceiver 200, and the optical transmission apparatus 2 is provided with the optical transceivers B1 to B25 each having the same configuration as the optical transceiver 200.

Similarly to the first example embodiment, when the instruction signal INS is received, the optical transceiver A2 and the optical transceiver B2 transmit channel setting optical signals while changing the local channel information L, that is, sweeping a local channel, thereby starting autonomous channel setting. However, the present example embodiment assumes that it is known in advance that the channel CH3 is assigned as a transmission channel of the optical transceiver A2 and the channel CH4 is assigned as a transmission channel of the optical transceiver B2. Therefore, in order to manually perform channel setting after the start of the autonomous channel setting, a user gives the optical transceiver A2 an instruction signal INS_M for designating channels to be used for transmission and reception.

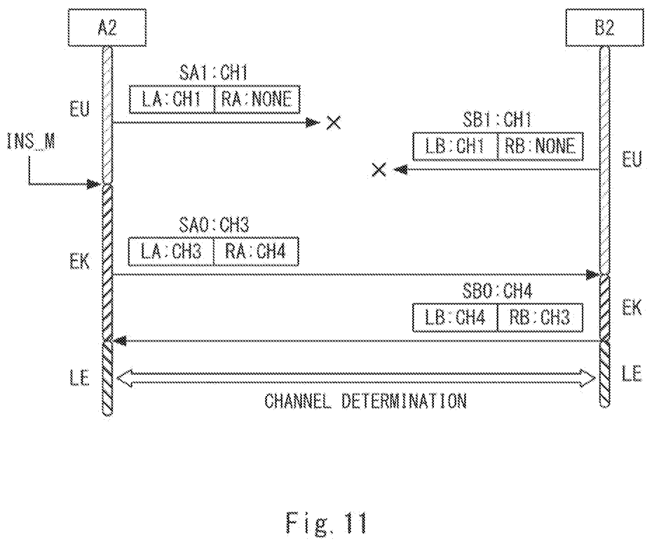

Hereinafter, a channel setting operation will be described in order. FIG. 11 illustrates an example of channel setting optical signals transmitted and received between the optical transceiver A2 and the optical transceiver B2 in channel setting processing in the second example embodiment. Here, an example will be described in which the instruction signal INS_M is given to the optical transceiver A2 and the manual channel setting is performed after each of the optical transceiver A2 and the optical transceiver B2 transmits a channel setting signal once.

### (1) SA1/LA: CH1 and RA: None

In the example of FIG. 11, similarly to the example of FIG. 8, the optical transceiver A2 first transmits a channel setting optical signal SA1 for the channel CH1 in which the local channel information LA indicates the channel CH1 and the remote channel information RA is empty (NONE). In this example, the channel CH1 is a channel to be used for transmission from the optical transceiver A1 to the optical transceiver B1. That is, the reception port of the optical transceiver B1 is connected to the port for the channel CH1 in the optical multiplexer/demultiplexer M2 of the optical transmission apparatus 2. Therefore, the channel setting optical signal SA1 is blocked by the optical multiplexer/demultiplexer M2 and does not reach the optical transceiver B2.

### (2) SB1/LB: CH1 and RB: None

Next, similarly to the example of FIG. 8, the optical transceiver B2 transmits the channel setting optical signal SB1 for the channel CH1 in which the local channel information LB indicates the channel CH1 and the remote channel information RB is empty (NONE). Since the transmission port of the optical transceiver A1 is connected to the port for the channel CH1 in the optical multiplexer/demultiplexer M1 of the optical transmission apparatus 1, the channel setting optical signal SB1 is blocked by the optical multiplexer/demultiplexer M1 and does not reach the optical transceiver A2.

### (3) Input of INS_M

Here, the user gives the instruction signal INS_M to the optical transceiver A2 in order to allocate the channel CH3 as the transmission channel of the optical transceiver A2 and allocate the channel CH4 as the transmission channel of the optical transceiver B2. When receiving the instruction signal INS_M, the optical transceiver A2 stops the autonomous channel setting, that is, channel sweeping.

### (4) SA0/LA: CH3 and RA: CH4, and State Transition: EU to EK

In response to the instruction signal INS_M, the optical transceiver A2 transmits the channel setting optical signal SA0 for the channel CH3 in which the local channel information LA is fixed to the channel CH3 and the remote channel information RA is fixed to the channel CH4. The channel setting optical signal SA0 for the channel CH3 is received by the optical transceiver B2. At this time, since the optical transceiver A2 is in a state in which the channels to be used for transmission and reception are detected, the state of the optical transceiver A2 transitions from EU to EK.

Similarly to the case of FIG. 8, the optical transceiver B2 receives the channel CH3 as the local channel information LA of the optical transceiver A2 and the channel CH4 as the remote channel information RA of the optical transceiver A2. The local channel information LA and the remote channel information RA of the optical transceiver A2 are respectively the remote channel information RB and the local channel information LB for the optical transceiver B2. Therefore, the optical transceiver B2 fixes the local channel information LB to the channel CH4 and fixes the remote channel information RB to the channel CH3. Note that the transmission channel of the optical transceiver B2 is set by fixing the local channel information LB and the remote channel information RB, and thus, the optical transceiver B2 stops the channel sweeping. As a result, the optical transceiver B2 is in a state (state EK) in which the transmission channel of the optical transceiver A2 as the partner and a channel through which transmission from the optical transceiver B2 to the optical transceiver A2 is possible are detected, and thus, the state transitions from EU to EK.

### (5) SB0/LB: CH4 and RB: CH3, and State Transition: EK to LE

The optical transceiver B2 transmits a channel setting optical signal SB0 for the channel CH4 in which the local channel information LB is fixed to the channel CH4 and the remote channel information RB is fixed to the channel CH3. The channel setting optical signal SB0 for the channel CH4 is received by the optical transceiver A2.

Similarly to the case of FIG. 8, the optical transceivers A2 and B2 can confirm that the local channel information LA of the optical transceiver A2 and the remote channel information RB of the optical transceiver B2 coincide as the channel CH3, and the local channel information LB of the optical transceiver B2 and the remote channel information RA of the optical transceiver A2 coincide as the channel CH4. Therefore, assuming that the channel to be used for transmission and the channel to be used for reception are determined, the optical transceivers A2 and B2 transition to a state (state LE: Link Established) in which a link is established, and end the channel setting processing.

As a result, after the manual channel setting is completed, the optical transceiver A2 and the optical transceiver B2 can transmit and receive optical signals using the channels CH3 and CH4 as in the first example embodiment.

As described above, according to the present configuration, even after autonomous channel setting is started, an optical transceiver can stop the autonomous channel setting by receiving the instruction signal INS_M and set a transmission channel and a reception channel designated by the instruction signal INS_M. In addition, an optical transceiver, which is a communication partner of the optical transceiver having received the instruction signal, can also set a transmission channel and a reception channel by receiving a channel setting optical signal from the optical transceiver having received the instruction signal INS_M.

When viewed from a user of a system in which an optical transceiver is mounted, it is possible to manually and easily perform channel setting of two optical transceivers only by giving an instruction signal for designating channels to be used for transmission and reception to one of the two optical transceivers that transmit and receive optical signals.

As a result, it is possible to preferentially and quickly complete a channel setting operation by performing interrupt processing on the instruction signal INS_M by software without requiring channel sweeping in the autonomous channel setting. In the example of FIG. 11, transmission and reception of the channel setting optical signals SA2 to SA4 and SB2 to SB4 accompanying the channel sweeping can be reduced as compared with the example of FIG. 8, and it can be understood that a time required for the channel setting can be shortened by a time required for the reduced transmission and reception of the channel setting optical signals.

Although the above description has focused on the optical transceivers A2 and B2, it goes without saying that manual channel setting processing can be similarly executed for the other optical transceivers A1, A3 to A25, B1, and B3 to B25.

Note that the example in which the instruction signal is given to manually perform the channel setting when the two optical transceivers that transmit and receive optical signals are both in the state EU in which a transmission channel and a reception channel that need to be set are unknown has been described in the above description, but this is merely an example. That is, there may be a case where, after autonomous channel setting is started, each of two optical transceivers that transmit and receive optical signals are in the state PK in which a transmission channel of an optical transceiver as a partner is detected or the state EK in which channel setting is not established although the transmission channel of the optical transceiver as the partner and a channel through which transmission to the optical transceiver as the partner is possible are detected as illustrated in FIG. 8. Even in this case, it is possible to give an instruction signal to one of the two optical transceivers that transmit and receive optical signals to stop the autonomous channel setting performed by the optical transceiver having received the instruction signal and to manually set channels to be used for transmission and reception. Further, the optical transceiver that is a communication partner of the optical transceiver having received the instruction signal can also manually set channels to be used for transmission and reception by receiving a channel setting optical signal (that is, the channel setting optical signal SA0 or SB0 in FIGS. 8 and 11) from the optical transceiver having received the instruction signal.

### Third Example Embodiment

Although the channel setting in two optical transceivers that transmit and receive optical signals has been described in the first and second example embodiments, not only the above-described channel setting signal but also a control signal for an optical transceiver as a communication partner and a host apparatus to which the optical transceiver as the communication partner is connected can be superimposed as a signal to be superimposed on a main signal that is a data signal to be transmitted and received. In the present example embodiment, an optical transceiver capable of superimposing the control signal on the main signal will be described.

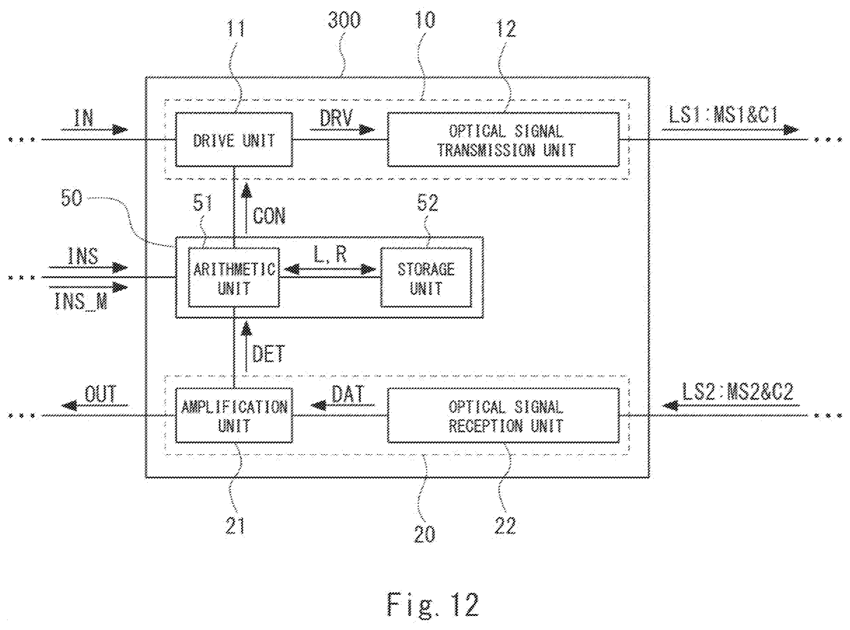

FIG. 12 schematically illustrates a configuration of an optical transceiver 300 according to a third example embodiment. The optical transceiver 300 according to the present example embodiment has a configuration in which the control unit 30 of the optical transceiver 100 is replaced with a control unit 50. An arithmetic unit 51 and a storage unit 52 of the control unit 50 correspond to the arithmetic unit 31 and the storage unit 32 of the control unit 30, respectively.

The optical transceiver 300 superimposes a control signal C1 for controlling an operation of an optical transceiver as a communication partner or a host apparatus to which the optical transceiver as the communication partner is connected on the main signal MS1 and outputs an optical signal LS1. Further, the optical transceiver 300 is configured to be able to receive an optical signal LS2, which is output from the optical transceiver as the communication partner and obtained by superimposing a control signal C2 on the main signal MS2, and to operate according to the control signal C2. Note that transmission and reception of the control signals are similar to transmission and reception of the channel setting optical signals, and thus, description thereof will be omitted.

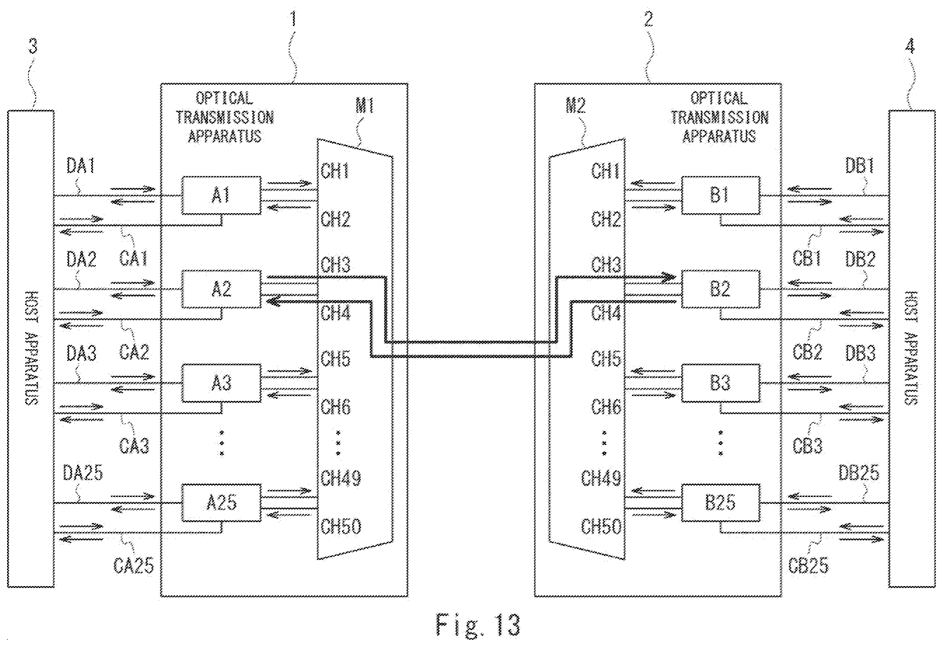

Next, transmission of a control signal and an operation corresponding thereto in the present example embodiment will be described. FIG. 13 schematically illustrates a configuration of an optical communication system according to the third example embodiment and an example of transmission and reception of optical signals. Similarly to the first and second example embodiments, it is assumed that the optical transmission apparatus 1 is provided with the optical transceivers A1 to A25 each having the same configuration as the optical transceiver 300, and the optical transmission apparatus 2 is provided with the optical transceivers B to B25 each having the same configuration as the optical transceiver 300.

The optical transceivers A1 to A25 installed in the optical transmission apparatus 1 are connected to a host apparatus 3 that performs communication with a partner through the optical transceivers A1 to A25 and performs various types of processing necessary for the communication. Each of the optical transceivers A1 to A25 and the host apparatus 3 are connected by each of data communication lines DA1 to DA25 for exchanging a data signal modulated into a main signal and transmitted by each transceiver and a data signal demodulated from a received main signal, and are connected by each of communication lines CA1 to CA25 for exchanging electrical signals other than the data signals.

The optical transceivers B1 to B25 installed in the optical transmission apparatus 2 are connected to a host apparatus 4 that performs communication with a partner through the optical transceivers B1 to B25 and performs various types of processing necessary for the communication. The optical transceivers B1 to B25 and the host apparatus 4 may be connected by data communication lines DB1 to DB25 for exchanging a data signal modulated into a main signal and transmitted by each transceiver and a data signal demodulated from a received main signal, and may be connected by communication lines CB1 to CB25 for exchanging electrical signals other than the data signals.

For simplification of description, an example in which a control signal CS superimposed on a main signal is transmitted from the optical transceiver A2 to the optical transceiver B2 will be described.

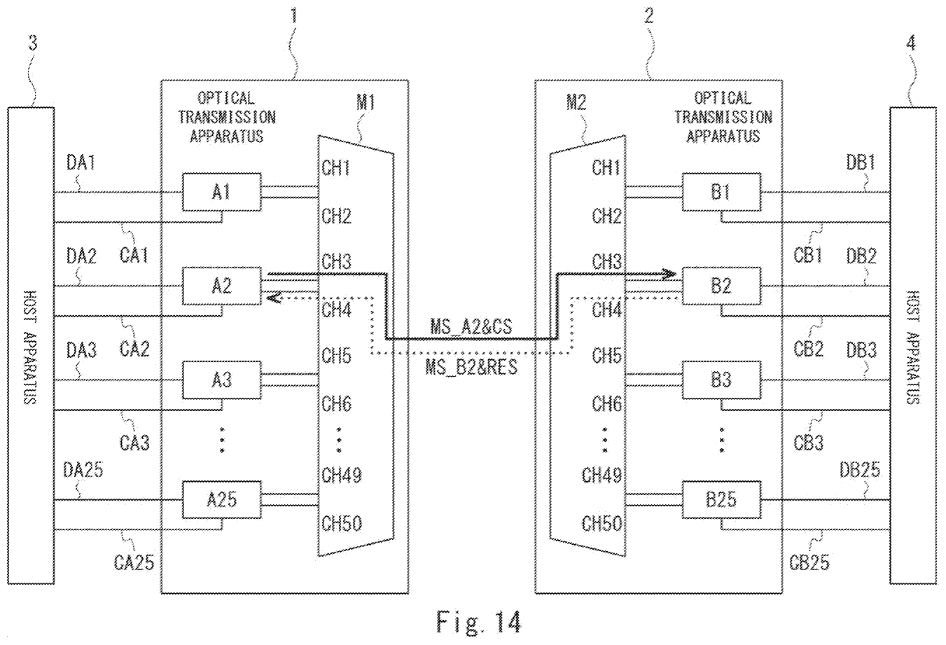

First, a case where an optical transceiver as a communication partner is controlled will be described. FIG. 14 schematically illustrates a signal flow in a case where the optical transceiver as the communication partner is controlled in the third example embodiment. The optical transceiver A2 as a transmission source can instruct the optical transceiver B2 as a communication partner to turn on and off optical output, that is, to start and stop transmission of an optical signal by transmitting the control signal CS superimposed on a main signal MS_A2. Note that the optical transceivers can output control signals in response to provision of signals such as the instruction signal INS and the instruction signal INS_M.

Further, the optical transceiver A2 can make a request for information such as a setting parameter of the optical transceiver B2 as the communication partner by transmitting the control signal CS superimposed on the main signal MS_A2. The optical transceiver B2 having received the request transmits a response signal RES indicating the held information and being superimposed on a main signal MS_B2 to the optical transceiver A2. The optical transceiver A2 receives the response signal RES, converts the response signal RES into a response signal RES_E that is an electrical signal, and forwards the response signal RES_E to the optical transmission apparatus 1 and other apparatuses as necessary. The information to be requested is, for example, setting information such as a transmission channel, a reception channel, optical output, an optical input level, a transceiver temperature, laser state monitoring (a wavelength monitor, a laser temperature, and a laser current value), an optical transceiver product name, and a version of a program main body.

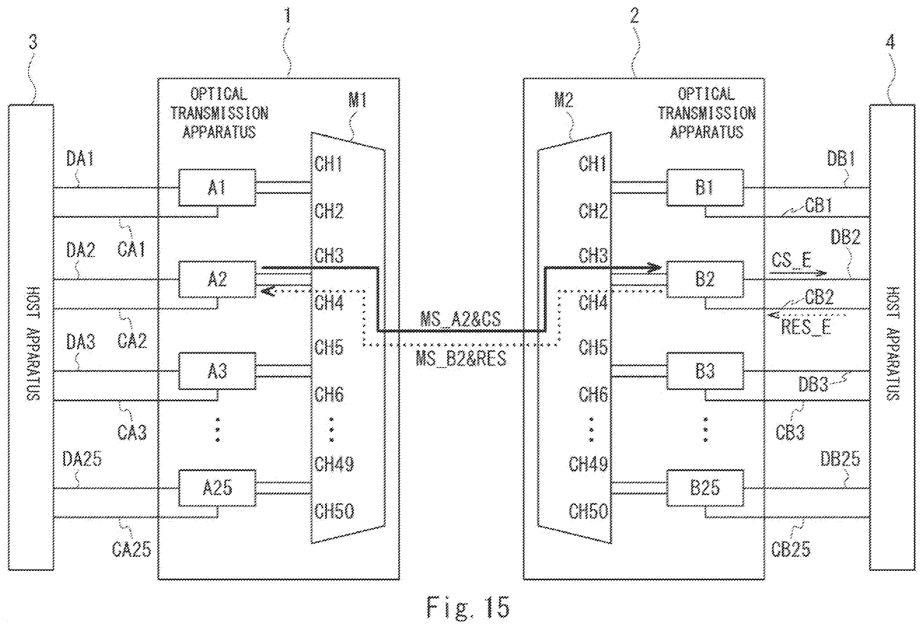

Next, a case where a host apparatus of the communication partner is controlled will be described. FIG. 15 schematically illustrates a signal flow in the case where the host apparatus to which the optical transceiver as the communication partner is connected is controlled in the third example embodiment. The optical transceiver A2 can also give an instruction for on and off of communication processing in the host apparatus 4 to which the optical transceiver B2 as the communication partner is connected by transmitting the control signal CS. In this case, the optical transceiver A2 transmits the control signal CS to the optical transceiver B2, and the optical transceiver B2 receives the control signal CS, converts the control signal CS into a control signal CS_E that is an electrical signal, and forwards the control signal CS_E to the host apparatus 4 through the communication line DB2. The host apparatus 4 can stop and start the communication processing according to the control signal CS_E.

Further, the optical transceiver A2 can request information held by the host apparatus 4 to which the optical transceiver B2 as the communication partner is connected by transmitting the control signal CS. In this case, the host apparatus 4 outputs the response signal RES_E, which is an electrical signal indicating the information requested by the control signal CS_E, to the optical transceiver B2 through the communication line CB2. The optical transceiver B2 transmits an optical signal obtained by superimposing the response signal RES_E on the main signal MS_B2 as an optical signal RES to the optical transceiver A2. The optical transceiver A2 receives the response signal RES, converts the response signal RES into the response signal RES_E that is an electrical signal, and forwards the response signal RES_E to the host apparatus 3 through the communication line DA2 or to other apparatuses as necessary. The requested information is, for example, setting information such as the number of connected optical transceivers and transmission and reception channels of the optical transceivers.

As described above, according to the present configuration, a control signal superimposed on a main signal is transmitted from one of two optical transceivers that transmit and receive optical signals to the other optical transceiver as a communication partner, thereby enabling control of operations of the optical transceiver as the communication partner and a host apparatus to which the optical transceiver as the communication partner is connected.

The optical communication system illustrated in FIG. 13 described in the present example embodiment is used in, for example, a 5th generation mobile communication system (hereinafter, referred to as 5G). In such a system, it is known that a base station provided with an optical transmission apparatus is often installed in a place where it is relatively difficult to approach, such as a mountain, a rooftop of a building, or a region where a railroad is laid. In this case, it is difficult for workers to reach the base station in the first place, and a worker with special skills is required. On the other hand, according to the present configuration, a control signal can be transmitted from an optical transceiver in a remote base station to a target optical transceiver to remotely control operations, and thus, it is possible to cause the target optical transceiver or the optical transmission apparatus to perform a desired operation without dispatching a worker to the base station. Therefore, personnel, cost, and time required for maintenance and inspection work of the optical transceiver, the optical transmission apparatus, and the like can be greatly reduced.

Further, it is known that the number of installed base stations is relatively large in the 5G because the frequency used for communication is high as compared with previous mobile communication systems. Therefore, it is possible to cause the optical transmission apparatus and the optical transceiver in the base station to perform a desired operation by performing remote control as in the present configuration even in a case where many base stations are installed. As a result, it is possible to effectively suppress an increase in personnel, cost, and time required for the maintenance and inspection work caused by an increase in the number of base stations.

### Fourth Example Embodiment

An optical transceiver according to a fourth example embodiment will be described. In superimposing one or both of the channel setting optical signal and the control signal described in the above-described embodiments, the optical transceiver according to the fourth example embodiment is configured to change the optical signals as the superimposed channel setting optical signal and the control signal in conjunction with each other according to a variation in the light intensity of a main signal, that is, a variation in the amplitude.

In order to simplify the description, a signal superimposed on a main signal is hereinafter referred to as a superimposed signal. The superimposed signal may include one or both of the channel setting optical signal and the control signal described in the above-described example embodiments, and other optical signals other than the main signal.

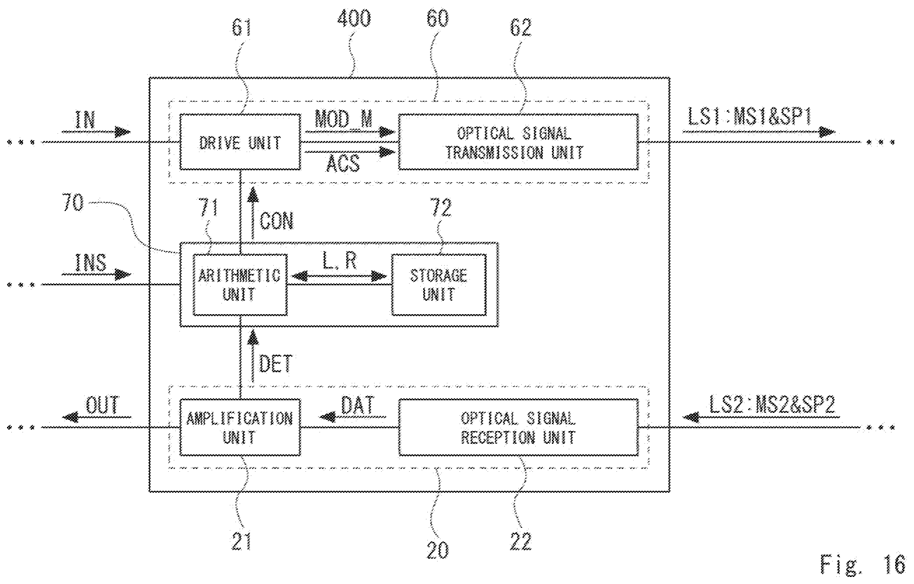

FIG. 16 schematically illustrates a configuration of an optical transceiver 400 according to the fourth example embodiment. The optical transceiver 400 according to the present example embodiment has a configuration in which the wavelength-tunable optical transmission unit 10 of the optical transceiver 100 is replaced with a wavelength-tunable optical transmission unit 60 and the control unit 30 is replaced with a control unit 70. An arithmetic unit 71 and a storage unit 72 of the control unit 70 correspond to the arithmetic unit 31 and the storage unit 32 of the control unit 30, respectively.

The optical transceiver 400 outputs an optical signal LS1 obtained by superimposing a signal SP1 to be superimposed on the main signal MS1. In addition, the optical transceiver 400 is configured to receive the optical signal LS2 in which a signal SP2 to be superimposed has been superimposed on the main signal MS2 output from an optical transceiver as a communication partner, and to be operable according to the superimposed signal SP2.

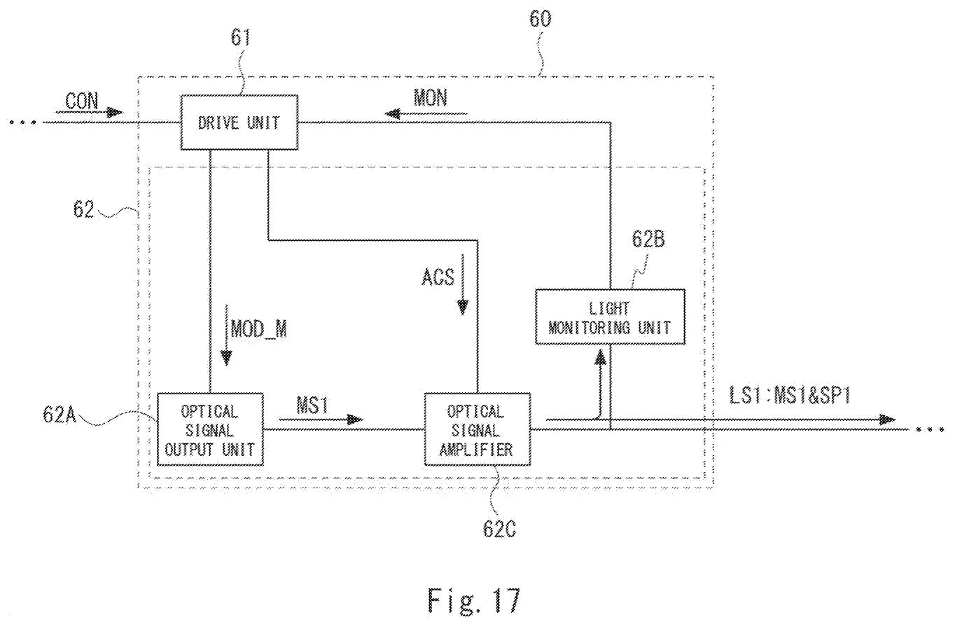

FIG. 17 schematically illustrates a configuration of the wavelength-tunable optical transmission unit 60 according to the fourth example embodiment. The wavelength-tunable optical transmission unit 60 includes a drive unit 11 and an optical signal transmission unit 12 corresponding to the drive unit 61 and the optical signal transmission unit 62 in the wavelength-tunable optical transmission unit 10, respectively. A drive signal DRV output from the drive unit 61 to the optical signal transmission unit 62 includes a main signal modulation signal MOD_M which is a signal for modulating the main signal and an amplification control signal ACS for controlling an amplification operation of an optical signal amplifier 62C. The main signal modulation signal MOD_M is output based on a main signal IN which is a data signal. In addition, the amplification factor of the optical signal amplifier 62C can be controlled by the amplification control signal ACS.

The optical signal transmission unit 62 includes an optical signal output unit 62A, a light monitoring unit 62B, and the optical signal amplifier 62C. The optical signal output unit 62A includes a light source and an optical modulator, modulates laser light according to the main signal modulation signal MOD_M, and outputs the main signal MS1. The light monitoring unit 62B is provided on the output side of the optical signal amplifier 62C and monitors output light of the optical signal amplifier 62C. The optical signal amplifier 62C amplifies the main signal MS1 output from the optical signal output unit 62A according to the amplification control signal ACS. The optical signal amplifier 62C may be configured as a semiconductor optical amplifier (SOA).

That is, in this configuration, by providing the amplification control signal ACS to the optical signal amplifier 62C according to the result of monitoring the intensity of the output light of the optical signal amplifier 62C by the light monitoring unit 62B, it is possible to perform an APC operation of performing feedback control such that the average value of the intensity of the output light of the optical signal amplifier 62C becomes a constant value.

Furthermore, in the present configuration, as will be described later, the amplification control signal ACS can include a modulation signal for superimposing, on the main signal MS1, the signal SP1 to be superimposed, based on a control signal CON from the control unit 70. As a result, the optical signal amplifier 62C can superimpose, on the main signal MS1, the signal SP1 to be superimposed, by modulating the main signal MS1 into a signal having a waveform whose amplitude transitions between two levels by amplitude-shift keying (ASK) or phase-shift keying (PSK) according to the amplification control signal ACS.

In this configuration, the monitoring unit 62B may monitor the amplitude of the optical signal LS1 in which the signal SP1 to be superimposed has been superimposed on the main signal MS1 and that has been output from the optical signal amplifier 62C, and the average values of the amplitude and the light intensity of the superimposed signal SP1 may be feedback-controlled according to the result of the monitoring.

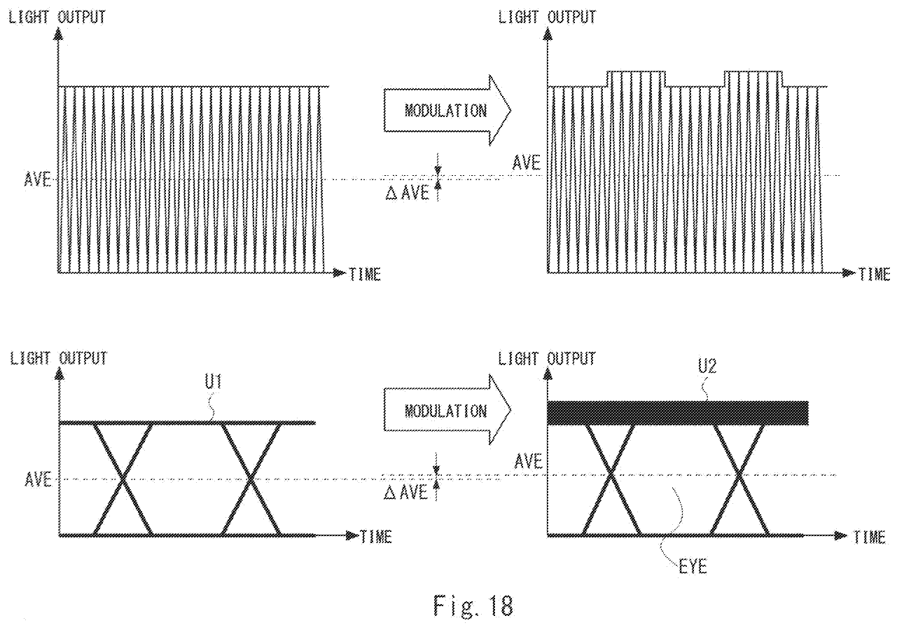

In the present example embodiment, the signal to be superimposed is superimposed on the main signal by modulating the main signal into a signal having a waveform whose amplitude transitions between two levels by amplitude shift-keying or phase shift-keying. FIG. 18 schematically illustrates a waveform and an eye pattern of a main signal before and after modulation is performed. When the main signal is modulated, the superimposed signal appears in a stepwise manner at the amplitude upper limit of the main signal (upper right part of FIG. 18). Furthermore, in order to maintain the signal quality, it is required to keep the amplitude of the superimposed signal within a certain range with respect to the amplitude of the main signal. In an eye pattern generally known as a method for evaluating signal quality, the amplitude of a superimposed signal appears as a variation of a trajectory of the signal drawn in the eye pattern, that is, a width of the trajectory. In FIG. 18, while the upper trajectory of the eye pattern in a case where the main signal is not modulated is similar to the other trajectory (reference sign U1 in FIG. 18), when the main signal is modulated, the amplitude of the main signal changes in a stepwise manner, and thus the upper trajectory of the eye pattern becomes thick (reference sign U2 in FIG. 16). When the upper trajectory of the eye pattern becomes thicker than the limit, the eye (symbol EYE in FIG. 18) of the eye pattern becomes narrow, leading to a reduction in the signal quality. Therefore, it is necessary to control the amplitude of the superimposed signal so as not to cause a reduction in the signal quality.

In addition, when the main signal is simply amplified and modulated as illustrated in FIG. 18, the average value of the intensity of the modulated signal increases by ΔAVE. However, the intensity (hereinafter, the average value AVE of the intensity of the optical signal is referred to) of the optical signal transmitted from the optical transceiver needs to be maintained constant by an auto power control (APC) operation in order to maintain the transmission quality of the optical signal.

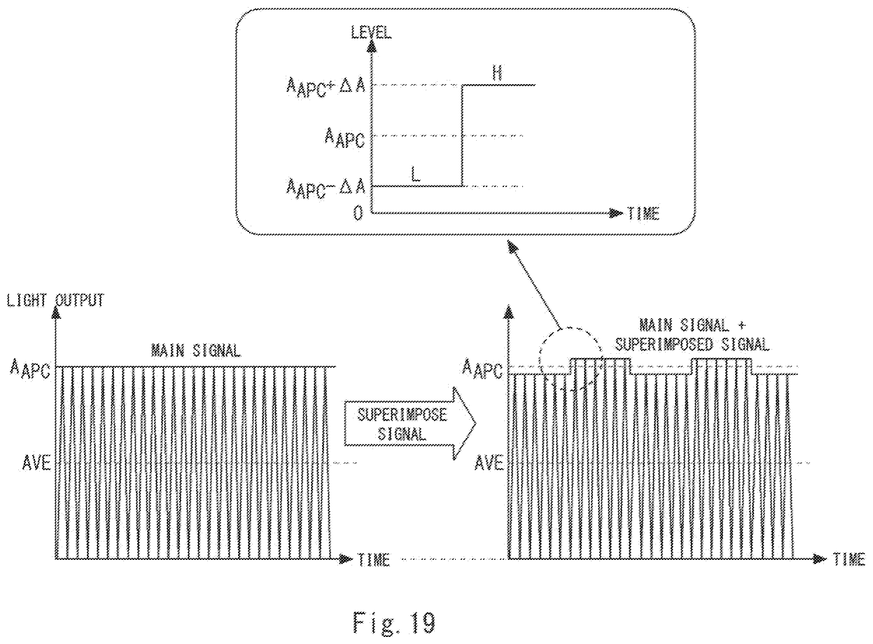

Therefore, it is conceivable to perform modulation so as to increase and decrease the amplitude of the main signal in a stepwise manner such that the main signal exceeds and falls below the upper limit of the amplitude of the main signal before modulation. FIG. 19 illustrates an example (hereinafter, referred to as a comparative example) in which a main signal is modulated and a signal to be superimposed is superimposed. In this example, the optical signal output from the optical signal amplifier 62C is an optical signal modulated as a signal whose amplitude increases and decreases by a width of ΔA such that the optical signal exceeds and falls below the amplitude upper limit A_{APC} of the optical signal whose light intensity has been adjusted to a target value by the APC operation. As a result, the signal to be superimposed can be superimposed on the main signal without a change in the average value of the intensity of the optical signal before and after the modulation.

In the case of performing such modulation, it is simply possible to superimpose, on the main signal, the signal to be superimposed, by performing the modulation such that the amplitude increases and decreases with a fixed modulation factor with respect to the amplification factor of the optical signal amplifier 62C (hereinafter, this modulation scheme is referred to as a comparative example). The comparative example will be described below with reference to the configuration of the transceiver 400 described above. Here, the amplification factor for achieving the target light intensity by the APC operation is set to a, the modulation factor for superimposing the signal to be superimposed is set to B, and the amplitude of the main signal MS1 input to the optical signal amplifier 62C is set to A_{IN}. In this case, the amplitude of the signal superimposed on the optical signal output from the optical signal amplifier 62C changes in a stepwise manner between α(1+β)·A_{IN} and α(1−β). A_{IN}. In the APC operation, since the amplification factor α is adjusted according to the light intensity of the optical signal output from the optical signal amplifier 62C, the amplitude α·β1·P_{IN} (ΔA described above) of the superimposed optical signal changes according to the amplification factor α and the intensity P_{IN} of the main signal MS1 input to the optical signal amplifier 62C.

In general, the temperature inside the optical transceiver varies due to an environment in which the optical transceiver is installed, heat generation of components mounted on the optical transceiver, and the like. As a result, temperature characteristics occur in the light source, the optical modulator, an optical amplifier, and the like provided for outputting an optical signal. In addition, characteristics of the optical transceiver vary due to aging of the optical transceiver or the like. It is known that, when such a variation in the characteristics, such as a variation in the temperature characteristics and aging, occurs, even if the amplification control signal ACS having the same value is given to the optical signal amplifier 62C, in other words, even if a current value given to the amplification control signal ACS is the same, the intensity of the optical signal output from the optical signal amplifier 62C also varies.

In particular, in recent years, some or all configurations of the wavelength-tunable optical transmission unit may be manufactured by applying silicon photonics technology. It is known that optical characteristics of an element manufactured by silicon photonics technology are likely to change due to a change in temperature, and it is required to suitably compensate for temperature characteristics.

Therefore, in the optical transceiver, in order to compensate for a variation in the characteristics such as the temperature characteristics and aging, the intensity of the optical signal output from the optical signal amplifier is monitored, and APC control is performed such that the intensity of the optical signal is constant. As a result, when the modulation scheme according to the comparative example is used, the amplitude of the superimposed signal varies due to a variation in the characteristics.

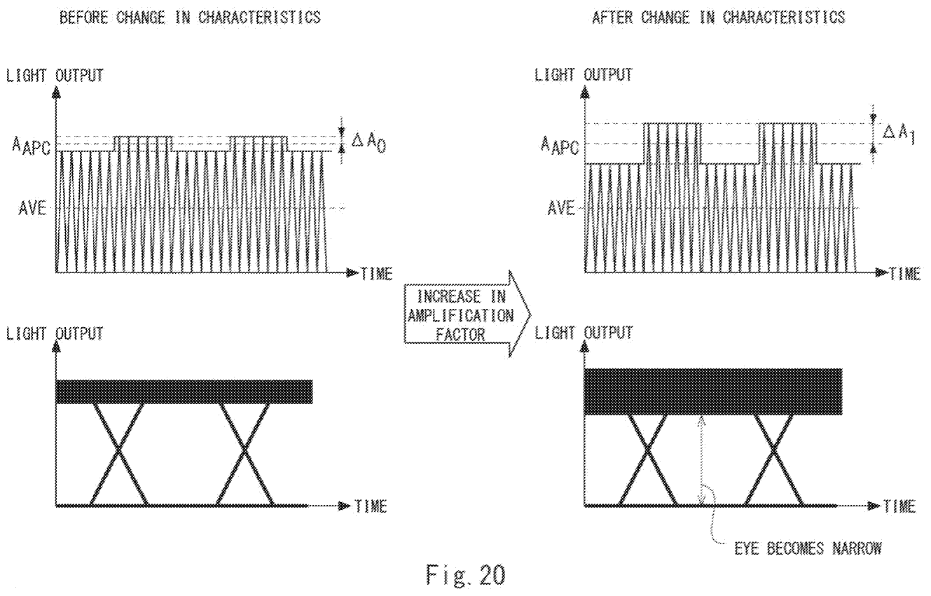

FIG. 20 illustrates a change in the amplitude of the superimposed signal in the comparative example in a case where the amplification factor increases due to a variation in the characteristics of the optical transceiver. When the amplitude A_{IN} of the main signal MS1 input to the optical signal amplifier 62C decreases, the amplification factor α in the optical signal amplifier 62C increases by the APC operation in order to compensate for the decrease. In this case, since the amplitude α·β1·P_{IN} of the superimposed optical signal also increases, the amplitude ΔA₁ of the superimposed signal when the characteristic variation occurs becomes larger than the amplitude ΔA₀ of the superimposed signal before the characteristic variation occurs. In this case, the eye of the eye pattern is narrowed by the superimposed signal having the increased amplitude, which causes a reduction in the signal quality. In addition, since the amplitude of the superimposed signal to be transmitted changes, the signal quality of the superimposed signal decreases.

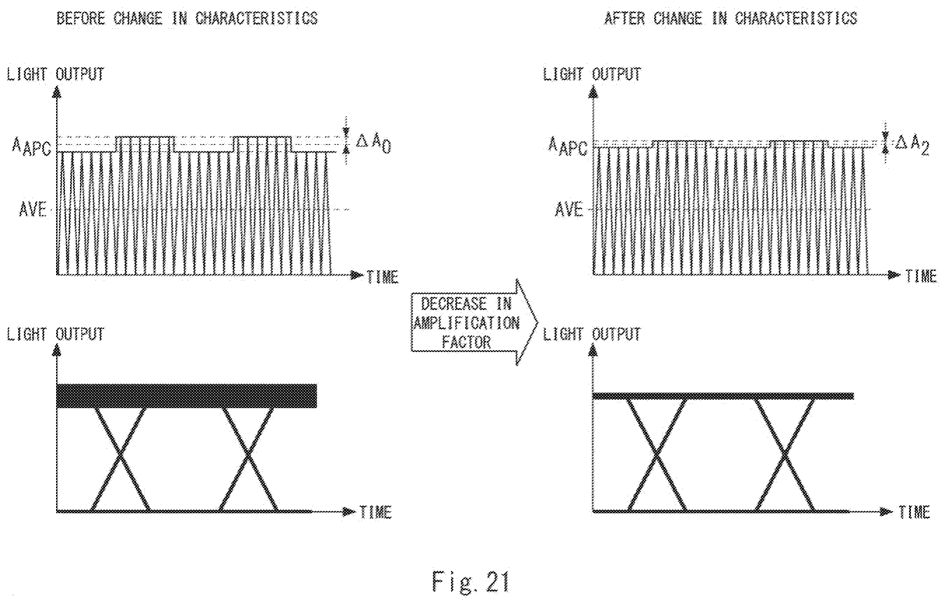

FIG. 21 illustrates a change in the amplitude of the superimposed signal in the comparative example in a case where the amplification factor decreases due to a variation in the characteristics of the optical transceiver. When the amplitude A_{IN} of the main signal MS1 input to the optical signal amplifier 62C increases, the amplification factor α in the optical signal amplifier 62C decreases by the APC operation in order to compensate for the increase. In this case, since the amplitude α·β1·P_{IN} of the superimposed optical signal also decreases, the amplitude ΔA2 of the superimposed signal when the characteristic variation occurs becomes smaller than the amplitude ΔA₀ of the superimposed signal before the characteristic variation occurs. In this case, although the eye of the eye pattern is not narrowed, the signal quality of the superimposed signal is reduced.

Therefore, as described below, the optical transceiver 400 according to the present example embodiment controls the optical output amplifier 62C such that the intensity of the optical signal output from the optical output amplifier 62C and the amplitude of the superimposed signal are maintained constant by the APC operation.

The control of the amplitude of the superimposed signal in the optical transceiver 400 will be described below. The drive unit 61 controls the optical signal amplifier 62C such that the amplitude of the superimposed signal has a constant ratio with respect to the amplitude of the main signal whose intensity has been adjusted to be constant by the APC operation. Assuming that the amplitude of the main signal MS1 adjusted by the APC operation is A_{APC} and the ratio (modulation degree) to be multiplied by the amplitude A_{APC} of the main signal MS1 to determine the amplitude of the superimposed signal SP1 is γ, the optical signal output from the optical signal amplifier 62C in the present example embodiment is a signal in which the amplitude changes in a stepwise manner between A_{APC}+γ·A_{APC} and A_{APC}−γ·A_{APC} such that the optical signal exceeds and falls below the amplitude upper limit A_{APC} (A_{APC}=a. A_{IN}) of the optical signal in which the light intensity has been adjusted to the target value by the APC operation. Note that γ is an arbitrary value larger than 0 and smaller than 1 (0<γ<1).

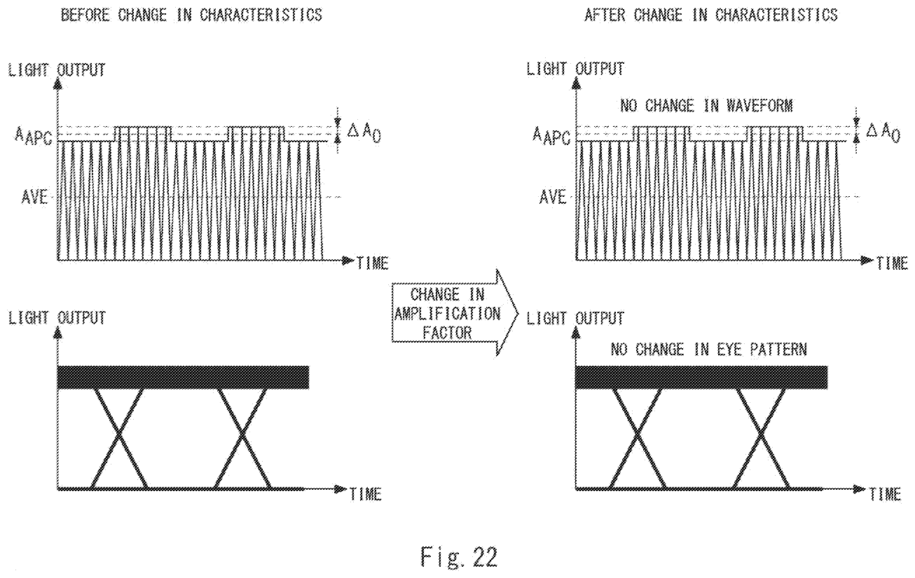

Since the amplitude upper limit A_{APC} of the optical signal of which the light intensity has been adjusted to the target value by the APC operation is maintained constant, the amplitude of the superimposed signal SP1 is maintained without changing even if the characteristics of the optical transceiver change. FIG. 22 illustrates a signal waveform in a case where the amplitude of the superimposed signal SP1 is controlled according to the amplitude of amplified main signal MS1 in the transceiver 400. As illustrated in FIG. 22, even in a case where the amplification factor α varies, the amplitude of the superimposed signal SP1 does not change, and thus it is possible to maintain the signal quality without affecting the eye pattern of the optical signal output from the optical signal amplifier.

The ratio γ can be a value in a range in which the transmission quality of the main signal can be secured. That is, the ratio γ can be a value falling within a range defined by a lower limit value γ_{L} and an upper limit value γ_{H}. As an example of the range of the ratio γ in which the transmission quality of the main signal can be secured, the lower limit value γ_{L} is 2% (0.02), and the upper limit value γ_{H} is 10% (0.1) (0.02≤γ≤0.1). A typical value of γ is, for example, 7.5% (0.075).

As described above, according to the present configuration, in superimposing, on the main signal, the signal to be superimposed, the amplitude of the superimposed signal can be set to a predetermined ratio with respect to the amplitude of the main signal whose intensity has been adjusted by the APC operation, and the signal to be superimposed can be superimposed on the main signal without affecting the transmission quality of the signal.

The control of the amplitude of the superimposed signal described in the present example embodiment can be performed at an arbitrary timing. The amplitude of the superimposed signal may be controlled, for example, as an initial setting operation at the time of introduction of the optical transceiver, or may be controlled after changing the transmission setting of the optical transceiver, such as after changing the channel of the optical signal to be transmitted or after changing the output value of the main signal. The amplitude of the superimposed signal may be controlled periodically or constantly after the operation of the optical transceiver is started. It goes without saying that the timing at which the drive unit performs control can be easily controlled by the control unit.

### Fifth Example Embodiment

An optical transceiver according to a fifth example embodiment will be described. While the amplitude of the superimposed signal is adjusted with reference to the result of monitoring the amplitude of the optical signal in the fourth example embodiment, the optical transceiver according to the present example embodiment is configured to adjust the amplitude of a superimposed signal based on information given in advance.

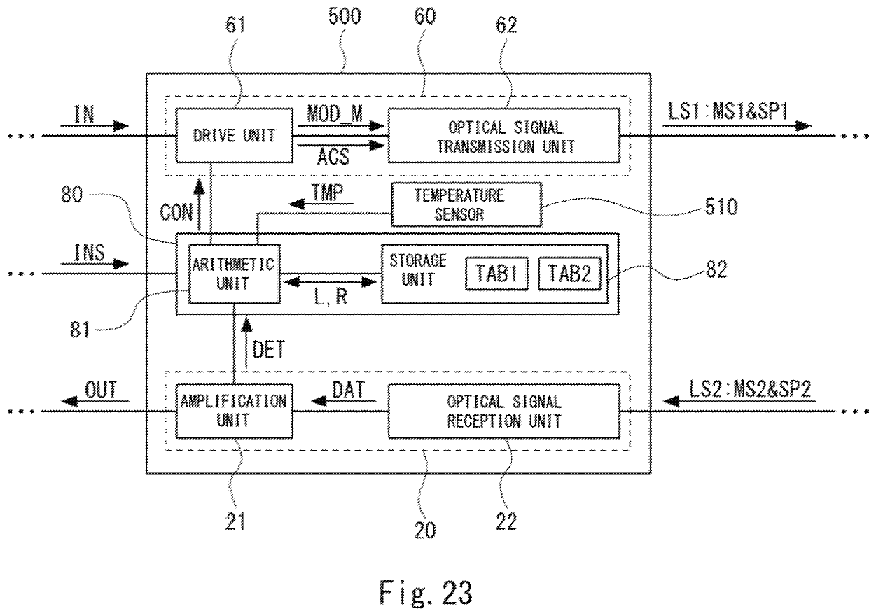

FIG. 23 schematically illustrates a configuration of an optical transceiver 500 according to the fifth example embodiment. The optical transceiver 500 according to the present example embodiment has a configuration in which the control unit 70 of the optical transceiver 400 is replaced with a control unit 80. An arithmetic unit 81 and a storage unit 82 of the control unit 80 correspond to the arithmetic unit 71 and the storage unit 72 of the control unit 70, respectively. In addition, the optical transceiver 500 is provided with a temperature sensor 510 for measuring the temperature inside the optical transceiver 500. The temperature sensor 510 can be installed at an arbitrary position of the optical transceiver 500, and may be provided inside a wavelength-tunable optical transmission unit 50, for example. The temperature sensor 510 outputs a temperature detection signal TMP indicating the measured temperature to the control unit 80.

In the storage unit 82, in order to compensate for the effect of a variation in the amplitude of the optical signal due to temperature characteristics of the light source, the optical modulator, the optical amplifier, and the like, the value of the amplification control signal ACS to be given to the optical signal amplifier 62C according to the temperature measured by the temperature sensor 510 is stored as, for example, table information TAB_1. The arithmetic unit 81 refers to the table information TAB_1 in the storage unit 82 based on the temperature indicated by the temperature detection signal TMP, and instructs the drive unit 61 on the value of the amplification control signal ACS to be output. In response to this, the drive unit 61 outputs the amplification control signal ACS to the optical signal amplifier 62C, and thus the amplitude of the superimposed signal can be adjusted to an appropriate range even in a case where the temperature changes.

As described above, in recent years, some or all configurations of the wavelength-tunable optical transmission unit may be manufactured by applying silicon photonics technology. It is known that optical characteristics of an element manufactured by silicon photonics technology easily change due to a change in temperature, and it can be considered that the control of the amplitude of the superimposed signal according to the temperature is important.

Here, it has been described that the amplitude of the superimposed signal is adjusted according to the temperature, but the amplitude of the superimposed signal may be adjusted according to a change in the optical transceiver over time. In this case, the storage unit 82 stores the value of the amplification control signal ACS to be given to the optical signal amplifier 62C according to the time elapsed from the start of the operation of the optical transceiver, for example, as table information TAB_2. The arithmetic unit 81 may be configured to be able to write the time elapsed from the start of operation of the optical transceiver to the storage unit 82 and read the time elapsed from the start of operation of the optical transceiver from the storage unit 82 as necessary. The arithmetic unit 81 refers to the table information TAB_2 in the storage unit 82 based on the time elapsed from the start of the operation of the optical transceiver, and instructs the drive unit 61 on the value of the amplification control signal ACS to be output. In response to this, the drive unit 61 outputs the amplification control signal ACS to the optical signal amplifier 62C, and thus the amplitude of the superimposed signal can be adjusted to an appropriate value even in a case where the optical transceiver changes over time.

As described above, according to the present configuration, the amplitude of the superimposed signal SP1 can be adjusted to a range of a predetermined ratio with respect to the amplitude of the main signal MS1 by referring to the information given in advance.

Note that the above-described control of the amplitude of the superimposed signal according to the temperature and the control of the amplitude of the superimposed signal according to the elapsed time may be implemented independently in the optical transceiver, or may be implemented in combination in the optical transceiver.

Furthermore, the information provided in advance is not limited to the above, and may be information associated with other than the temperature and the elapsed time.

### Sixth Example Embodiment

An optical transceiver according to a sixth example embodiment will be described. The optical transceiver according to the sixth example embodiment is configured to apply Manchester encoding as a modulation method in modulation of a main signal and superimposition of a signal to be superimposed. Needless to say, Manchester encoding is applicable to modulation of a signal to be superimposed, that is, a channel setting optical signal, a control signal, and other signals to be superimposed in the optical transceiver described in the above example embodiments.

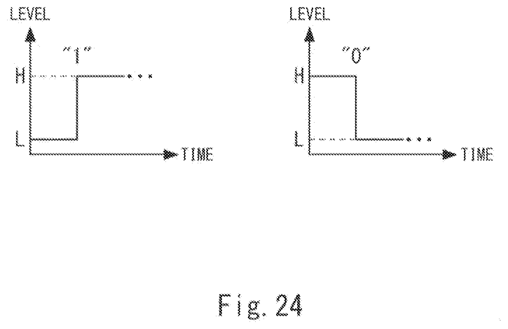

A Manchester encoded signal will be described. FIG. 24 illustrates a relationship between a signal and bits in Manchester encoding. In Manchester encoding, one bit can be transmitted in each period T, and the bit is represented by a transition of a signal at the center of the period T. In the present example embodiment, as illustrated in FIG. 24, a bit “0” is represented when the signal falls from a high level to a low level, and a bit “1” is represented when the signal rises from the low level to the high level.

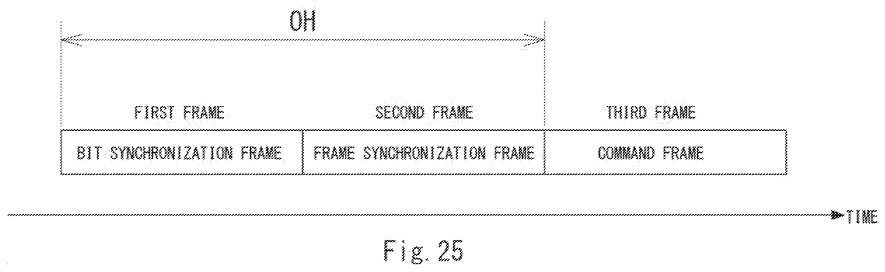

In the present example embodiment, in order to accurately receive the Manchester encoded superimposed signal, bit synchronization is performed by transmitting a superimposed signal for bit synchronization. In the present example embodiment, in order to perform the bit synchronization, the superimposed signal for bit synchronization is transmitted when an optical signal is transmitted from an optical transceiver on a transmission side. FIG. 25 is a diagram illustrating an example of the optical signal transmitted by the optical transceiver on the transmission side. As illustrated in FIG. 25, the optical transceiver on the transmission side first transmits a frame (bit synchronization frame) including the superimposed signal for bit synchronization, and then transmits a frame (frame synchronization frame) for frame synchronization. These frames correspond to the header information OH in FIG. 3. Thereafter, a frame including a command signal including an instruction to the reception side is transmitted. The frame including the command signal corresponds to the local channel information L and the remote channel information R in FIG. 3. Each frame includes continuous bit strings.

When receiving the superimposed signal for bit synchronization, the optical transceiver detects the transition of the signal at the timing when the superimposed signal transitions in order to decode a bit represented by the superimposed signal.

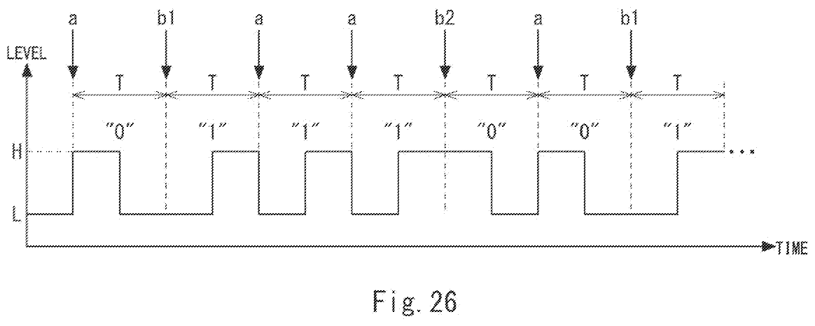

FIG. 26 illustrates an example of the superimposed signal for bit synchronization. The superimposed signal for bit synchronization in FIG. 26 corresponds to the detection signal DET output from the amplification unit 21 to the control unit 70 in FIG. 17. The level of the Manchester encoded superimposed signal always transitions at the center of the period representing the bit. On the other hand, depending on a bit string represented by the superimposed signal, there are a case where the level transitions at a boundary (timing a in FIG. 26) of periods and a case where the level does not transition (timings b1 and b2 in FIG. 26). The case where the level does not transition includes a case where the level is maintained at a low level (timing b1 in FIG. 26) and a case where the level is maintained at a high level (timing b2 in FIG. 26).

When the optical transceiver starts detecting the transition of the superimposed signal for bit synchronization, it is not clear whether the level transition is detected at a correct timing, that is, at the center of the period T. Therefore, the transition of the level at the boundary between the periods may be detected depending on the timing when the detection has been performed. In this case, since a level transition different from that representing the bit represented by the superimposed signal is detected, it is necessary to change the timing of detecting the level transition to the correct timing. Therefore, in the present example embodiment, in order to set the timing of detecting the level transition to the correct timing, a bit synchronization operation described below is performed.

The optical signal reception unit of the optical transceiver on the reception side performs bit synchronization using the bit synchronization frame to establish a state in which each bit represented by the superimposed signal can be accurately decoded. Next, frame synchronization is established using the frame synchronization frame. As a result, the command signal included in the frame including the command signal to be subsequently received can be accurately decoded.

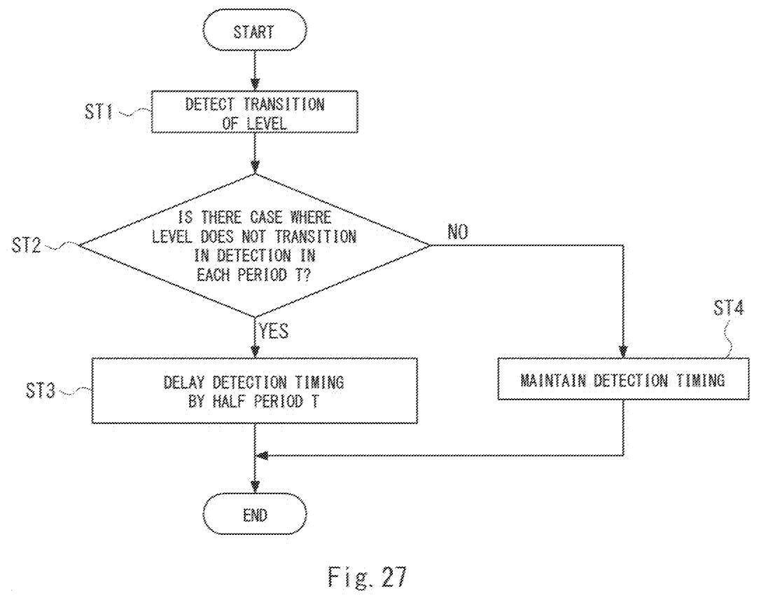

A procedure of the bit synchronization operation according to the present example embodiment will be described below. FIG. 27 is a flowchart illustrating the procedure of the bit synchronization operation in the sixth example embodiment.

### Step ST1

When receiving the superimposed signal for bit synchronization, the optical signal reception unit of the optical transceiver on the reception side detects a transition of the level in the bit synchronization frame at an arbitrary timing.

### Step ST2

After the transition of the level in the bit synchronization frame is detected at an arbitrary timing, the detection of a transition of the level of the superimposed signal is continued at the timing of each period T of Manchester encoding.

### Step ST3

As a result of continuing the detection of a transition of the level of the superimposed signal in the bit synchronization frame, in a case where there is a timing at which the level of the superimposed signal does not transition at the timing of each period T, the detection timing is changed such that the timing of detecting a transition of the level of the superimposed signal is delayed by half the period T.

### Step ST4

As a result of continuing the detection of a transition of the level of the superimposed signal in the bit synchronization frame, in a case where the level of the superimposed signal transitions at all timings in each period T, the timing of detecting a transition of the level of the superimposed signal is maintained as it is.

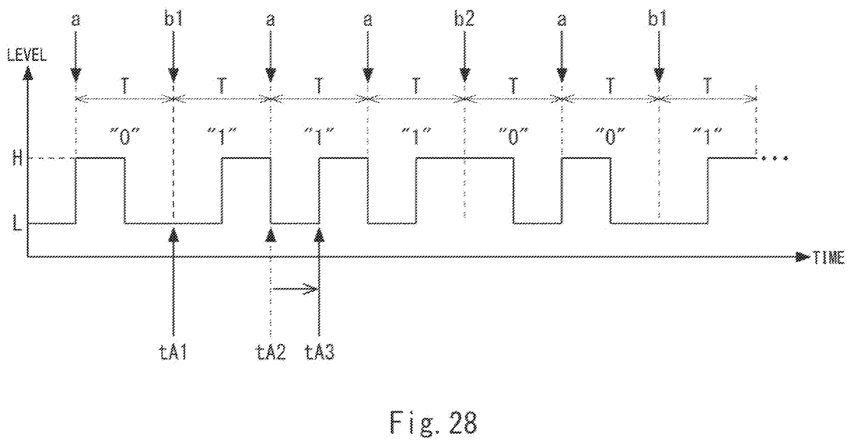

Next, the relationship between the bit synchronization operation according to the above-described procedure and the timing of detecting a transition of the level of the signal will be described. FIG. 28 illustrates a first example of the bit synchronization operation. When receiving the superimposed signal for bit synchronization, the optical signal reception unit starts detecting a transition of the level of the superimposed signal. At this time, since the level of the superimposed signal can transition not only at the center of each period T but also at boundaries between periods T, a timing at which the level of the superimposed signal does not transition at a boundary between periods T arrives on the optical signal reception unit side (timing tA1 in FIG. 28). In this case, since the timing at which the transition of the level of the superimposed signal is detected coincides with the boundary between the periods T, the optical signal reception unit delays the timing at which the transition of the level of the superimposed signal is detected by half the period T (step ST3 in FIG. 28). In FIG. 28, the detection timing is changed from the timing tA2 that is after the timing tA1 by the period T to the timing tA3 that is delayed by half the period T. As a result, the timing at which the transition of the level of the superimposed signal is detected coincides with the center of the period T (timing tA3 in FIG. 28), and the bit represented by the superimposed signal can be accurately detected.

Note that, in the above description, in step ST3, the optical signal reception unit changes the timing at which the transition of the level of the superimposed signal is detected to the timing tA3 by delaying the timing tA2 by half the period T. However, this is merely an example, and the optical signal reception unit may change the timing at which the transition of the level of the superimposed signal is detected to a timing delayed from the timing tA1 at which a shift in the detection is detected by half the period T. Also in this case, similarly, the timing at which the transition of the level of the superimposed signal is detected can be matched with the center of the period T.

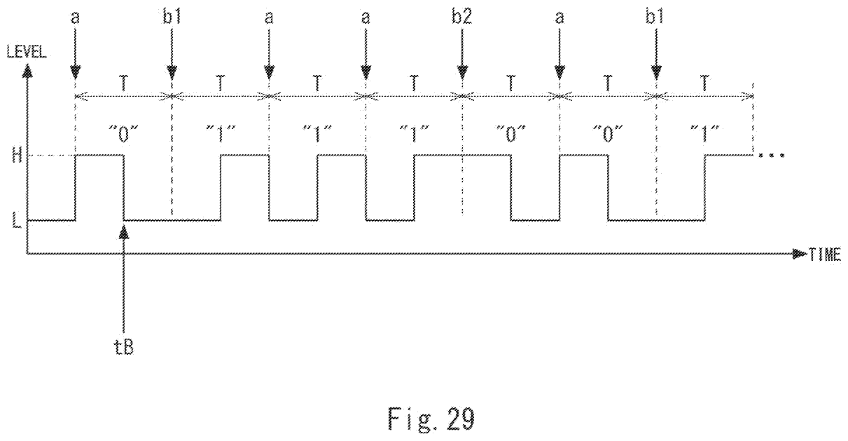

Next, FIG. 29 illustrates a second example of the bit synchronization operation. When the optical signal reception unit starts detecting a transition of the level of the superimposed signal in the superimposed signal for bit synchronization, the optical signal reception unit may detect the transition of the level at the center of the period T from the beginning (timing tB in FIG. 29, step ST1 in FIG. 27). In this case, even if the detection of a transition of the level in each period T is continued as it is (step ST2 in FIG. 27), the transition of the level is detected at the center of the period T in each period T. In this case, since the timing at which the transition of the level of the superimposed signal is already detected coincides with the center of the period T, the timing of detecting the transition of the level of the superimposed signal is maintained as it is after the end of the detection in the bit synchronization frame (step ST4 in FIG. 27).

As described above, according to the present configuration, when receiving the superimposed signal for bit synchronization that includes the bit string in which different bits are continuous, the optical signal reception unit can automatically and accurately read the bits represented by the superimposed signal for bit synchronization with a simple configuration and processing.

The superimposition of the signal on the main signal by Manchester encoding described in the present example embodiment is not limited to the application to the optical transceivers described in the first to fifth example embodiments, and can be applied to other optical transceivers.

### Other Example Embodiments

Note that the configurations according to the above-described example embodiments are not limited to the configurations described above, and can be appropriately changed without departing from the gist. For example, the optical transmission apparatuses may be connected to not only the network illustrated in FIG. 1 but also various networks including a trunk path and branch paths.

The number of optical transceivers and the number of channels provided in the optical transmission apparatuses are merely examples, and any number of optical transceivers and any number of channels may be provided.

The description has been given assuming that a wavelength-multiplexed signal is transmitted between the optical transmission apparatuses in the above example embodiments. However, it goes without saying that various multiplexing schemes other than wavelength multiplexing and various modulation systems can be applied to an optical signal to be transmitted.

The above-described optical transceivers have the configuration simplified to describe the optical transceivers according to the above-described example embodiments, and it goes without saying that various components such as a clock data recovery (CDR) unit may be included.

Although an example in which an optical signal subjected to on/off modulation is used as the channel setting optical signal has been described in the above description, an optical signal subjected to phase-shift keying other than the on/off modulation may be used as the channel setting optical signal.

Although the present invention has been mainly described as a hardware configuration in the above-described example embodiments, the present invention is not limited thereto, and the control of the wavelength-tunable optical transmission unit and the wavelength-tunable optical reception unit by the control unit and the channel setting processing can also be implemented by causing a central processing unit (CPU) to execute a computer program. In this case, the arithmetic unit included in the control unit may be configured as the CPU. The program includes an instruction (or software code) that, when read by a computer, causes a computer to execute one or more of the functions described in the above example embodiments. The program may be stored in a non-transitory computer-readable medium or a tangible storage medium. Examples of the non-transitory computer-readable medium or the tangible storage medium include, but are not limited to, a random-access memory (RAM), a read-only memory (ROM), a flash memory, a solid-state drive (SSD), or other types of storage technologies, for example, a compact disc (CD)-ROM, a digital versatile disc (DVD), a Blu-ray disc, or other types of optical disk storage devices, and a magnetic cassette, a magnetic tape, magnetic disk storage, or other magnetic storage devices. The program may be transmitted using a transitory computer-readable medium or a communication medium. Examples of the transitory computer-readable medium or the tangible storage medium may include, but are not limited to, electrical, optical, acoustic, or other forms of propagation signals.

As the storage unit provided in the control unit, various storage devices to and from which information can be written and read, such as a RAM, a flash memory, an SSD, an optical disk storage device, a magnetic cassette, a magnetic tape, and magnetic disk storage, can be used.

Although the invention of the present application has been described above with reference to the example embodiments, the invention of the present application is not limited to the above. Various modifications that can be understood by those skilled in the art can be made to the configuration and details of the invention of the present application within the scope of the invention.

### REFERENCE SIGNS LIST

1, 2 OPTICAL TRANSMISSION APPARATUS
3, 4 HOST APPARATUS
10, 60 WAVELENGTH-TUNABLE OPTICAL TRANSMISSION UNIT
11 DRIVE UNIT
12 OPTICAL SIGNAL TRANSMISSION UNIT
20 WAVELENGTH-TUNABLE OPTICAL RECEPTION UNIT
21 AMPLIFICATION UNIT
22 OPTICAL SIGNAL RECEPTION UNIT
30, 40, 50, 70, 80 CONTROL UNIT
31, 41, 51, 71, 81 ARITHMETIC UNIT
32, 42, 52, 72, 82 STORAGE UNIT
61 DRIVE UNIT
62 OPTICAL SIGNAL TRANSMISSION UNIT
62A OPTICAL SIGNAL OUTPUT UNIT
62B LIGHT MONITORING UNIT
62C OPTICAL SIGNAL AMPLIFIER
100, 200, 300, 400, 500, A1 to A25, B1 to B25 OPTICAL TRANSCEIVER
610 TEMPERATURE SENSOR
1000 OPTICAL COMMUNICATION SYSTEM
AMP OPTICAL AMPLIFIER
BS1, BS2 TERMINAL STATION
C1, C2 OPTICAL CABLE
CA1 to CA25, CB1 to CB25 DATA COMMUNICATION LINE
CS, CS_E CONTROL SIGNAL
CON CONTROL SIGNAL
DAT OUTPUT SIGNAL
DET DETECTION SIGNAL
DRV DRIVE SIGNAL
DA1 to DA25, DB1 to DB25 DATA COMMUNICATION LINE
IN MAIN SIGNAL
INS, INS_M INSTRUCTION SIGNAL
L, LA, LB LOCAL CHANNEL INFORMATION
LS1, LS2 OPTICAL SIGNAL
M1, M2 OPTICAL MULTIPLEXER/DEMULTIPLEXER
MS, MS1, MS2, MS_A2, MS_B2 MAIN SIGNAL
MOD_M MAIN SIGNAL MODULATION SIGNAL
ACS AMPLIFICATION CONTROL SIGNAL
MON MONITOR SIGNAL
OH HEADER INFORMATION
OUT OUTPUT SIGNAL
R, RA, RB REMOTE CHANNEL INFORMATION
RES, RES_E RESPONSE SIGNAL
S, S1, S2, SA, SA0 to SA4, SB, SB0 to SB4 CHANNEL SETTING OPTICAL SIGNAL
SP1, SP2 SUPERIMPOSED SIGNAL
TAB_1, TAB_2 TABLE INFORMATION
TMP TEMPERATURE DETECTION SIGNAL

What is claimed is:

1. An optical transceiver comprising:
an optical transmission unit that outputs a first optical signal obtained by superimposing an optical signal for giving an instruction to another optical transceiver on a first main signal that is an optical signal for transmitting communication data to the other optical transceiver;
an optical reception unit that receives a second optical signal from the other optical transceiver; and
a control unit that controls the optical transmission unit and the optical reception unit, wherein
the optical transmission unit
modulates the first main signal into a signal having a waveform whose amplitude transitions between two levels by amplitude shift-keying or phase shift-keying to superimpose a first superimposed signal, which is the optical signal superimposed on the first main signal, on the first main signal, and
controls an amplitude of the first superimposed signal based on a value obtained by multiplying an amplitude of the first main signal by a predetermined ratio.

2. The optical transceiver according to claim 1, wherein
an upper limit value of the amplitude of the first superimposed signal is a value obtained by adding the amplitude of the first main signal to a value obtained by multiplying the amplitude of the first main signal by the predetermined ratio, and
a lower limit value of the amplitude of the first superimposed signal is a value obtained by subtracting a value obtained by multiplying the amplitude of the first main signal by the predetermined ratio from the amplitude of the first main signal.

3. The optical transceiver according to claim 2, wherein
the optical transmission unit includes
an optical signal output unit that outputs the first main signal,
an optical signal amplifier that amplifies the first main signal output from the optical signal output unit;
a light monitoring unit that monitors the first optical signal output from the optical signal amplifier; and
a drive unit that drives the optical signal output unit and the optical signal amplifier, and
the drive unit controls the optical signal amplifier according to a result of monitoring the optical signal output from the optical signal amplifier by the light monitoring unit such that an average value of an intensity of the optical signal output from the optical signal amplifier is maintained constant, and such that the first superimposed signal is superimposed on the first main signal by modulating the first main signal into a signal having a waveform whose amplitude transitions between two levels by amplitude shift-keying or phase shift-keying.

4. The optical transceiver according to claim 2, comprising a temperature sensor that measures a temperature of the optical transceiver, wherein
the optical transmission unit includes
an optical signal output unit that outputs the first main signal,
an optical signal amplifier that amplifies the first main signal output from the optical signal output unit to superimpose, on the first main signal, the first superimposed signal, and
a drive unit that drives the optical signal output unit and the optical signal amplifier,
the control unit stores in advance first information in which the temperature of the optical transceiver and an instruction to be given to the drive unit are associated with each other,
the control unit gives a first instruction to the drive unit with reference to the first information according to the temperature measured by the temperature sensor, and the drive unit controls the optical signal amplifier according to the given first instruction such that an average value of an intensity of the optical signal output from the optical signal amplifier is maintained constant, and such that the first superimposed signal is superimposed on the first main signal by modulating the first main signal into a signal having a waveform whose amplitude transitions between two levels by amplitude shift-keying or phase shift-keying.

5. The optical transceiver according to claim 2, wherein
the optical transmission unit includes
an optical signal output unit that outputs the first main signal,
an optical signal amplifier that amplifies the first main signal output from the optical signal output unit to superimpose, on the first main signal, the first superimposed signal, and
a drive unit that drives the optical signal output unit and the optical signal amplifier,
the control unit stores in advance second information in which a time elapsed from start of operation of the optical transceiver and an instruction to be given to the drive unit are associated with each other,
the control unit gives a second instruction to the drive unit with reference to the second information according to the elapsed time, and
the drive unit controls the optical signal amplifier according to the given second instruction such that an average value of an intensity of the optical signal output from the optical signal amplifier is maintained constant, and such that the first superimposed signal is superimposed on the first main signal by modulating the first main signal into a signal having a waveform whose amplitude transitions between two levels by amplitude shift-keying or phase shift-keying.

6. The optical transceiver according to claim 1, wherein the first superimposed signal is superimposed on the first main signal by performing amplitude shift-keying on the first main signal by Manchester encoding.

7. The optical transceiver according to claim 1, wherein the second optical signal is an optical signal on which a second superimposed signal, which is an optical signal for giving an instruction to the optical transceiver, is superimposed by modulating a second main signal, which is an optical signal corresponding to communication data, into a signal having a waveform whose amplitude transitions between two levels by amplitude shift-keying or phase shift-keying by Manchester encoding, and
the optical reception unit
refers to information for synchronization that is included in the second superimposed signal,
detects a level of the second superimposed signal at a timing in each period of Manchester encoding in the information for synchronization after detection of a transition of the level of the second superimposed signal is started,
delays a timing of detecting the transition of the level of the second superimposed signal by half the period in a case where there is a timing at which the level of the second superimposed signal does not change in the detection of the level at the timing in each period,
maintains the timing of detecting the transition of the level of the second superimposed signal in a case where there is no timing at which the level of the second superimposed signal does not change in the detection of the level at the timing in each period, and
detects the transition of the level of the second superimposed signal at the determined timing.

8. The optical transceiver according to claim 7, wherein
the second superimposed signal includes
a bit synchronization frame that is the information for synchronization that is included in the second superimposed signal,
a frame synchronization frame to be used for frame synchronization after bit synchronization is performed by the bit synchronization frame, and
a command frame including information indicating an instruction to the optical transceiver.

9. An optical communication system comprising:
two opposing optical transmission apparatuses each including a plurality of optical transceivers and a first optical multiplexer/demultiplexer that multiplexes and outputs optical signals output from the plurality of optical transceivers and demultiplexes the received optical signals to the plurality of optical transceivers according to a channel; and
an optical cable that connects the two opposing optical transmission apparatuses, wherein
each of the optical transceivers of one of the optical transmission apparatuses includes
an optical transmission unit that outputs an optical signal obtained by superimposing an optical signal for giving an instruction to the other optical transceivers of the other optical transmission apparatus on a main signal that is an optical signal for transmitting communication data to the other optical transceivers;
an optical reception unit that receives optical signals from the other optical transceivers, and
a control unit that controls the optical transmission unit and the optical reception unit, and
each of the optical transmission units
modulates the main signal into a signal having a waveform whose amplitude transitions between two levels by amplitude shift-keying or phase shift-keying to superimpose a superimposed signal, which is the optical signal superimposed on the main signal, on the main signal, and
controls an amplitude of the superimposed signal based on a value obtained by multiplying an amplitude of the main signal by a predetermined ratio.

10. A method for controlling an optical transceiver, the optical transceiver including: an optical transmission unit that outputs an optical signal obtained by superimposing an optical signal for giving an instruction to another optical transceiver on a main signal that is an optical signal for transmitting communication data to the other optical transceiver; an optical reception unit that receives an optical signal from the other optical transceiver; and a control unit that controls the optical transmission unit and the optical reception unit, the method comprising:
modulating the main signal into a signal having a waveform whose amplitude transitions between two levels by amplitude shift-keying or phase shift-keying to superimpose a superimposed signal, which is the optical signal superimposed on the main signal, on the main signal; and
controlling an amplitude of the superimposed signal based on a value obtained by multiplying an amplitude of the main signal by a predetermined ratio.
